(19) United States
(12) Patent Application Publication
(10) Pub. No.: US 2025/0203147 A1
(43) Pub. Date: Jun. 19, 2025

(54) Methods and Apparatus for Streaming Augmented Reality Content Synchronized with Physical Objects and/or Digital Content Being Viewed

(71) Applicant: Charter Communications Operating, LLC, St. Louis, MO (US)

(72) Inventors: Omar Alami, Aurora, CO (US); Matthew Ringenberg, Englewood, CO (US)

(21) Appl. No.: 18/544,058

(22) Filed: Dec. 18, 2023

(51) Int. Cl. H04N 21/43; G06T 19/20; G06V 20/20; G06V 20/40; H04N 21/235; H04N 21/237; H04N 21/258; H04N 21/414; H04N 21/4223; H04N 21/431

(52) U.S. Cl. CPC H04N 21/4307; G06T 19/20; G06V 20/20; G06V 20/41; H04N 21/235; H04N 21/237; H04N 21/25891; H04N 21/41407; H04N 21/4223; H04N 21/4316; G06T 2219/2012

(57) ABSTRACT

Generating mixed reality (MR) or augmented reality content and displaying such content in a synchronized manner with the display of digital program content and/or viewing of actual objects in an environment is described. Methods support displaying relevant augmented reality (AR) content on a head mounted display or glasses. In some embodiments a MR HMD is synchronized to a physical display device such as a TV with the MR HMD device being supplied with a stream of high-fidelity images or holograms in a supplemental content stream. In one augmented reality embodiment content relevant to an object in the environment of the user device can be generated and displayed in accordance with preference information corresponding to user. The displayed object may have a color and/or features selected by the user with the generated image showing features not visible in an actual sample physical item present at the store or dealership.

### FIELD

The present application relates to methods and apparatus for creating augmented reality content, providing augmented reality content and/or supporting the display of augmented reality content, e.g., in a manner where provided content is synchronized with the viewing of physical objects and/or digital content.

### BACKGROUND

As head mounted display devices have decreased in cost and improved in quality, they are becoming more popular for virtual reality applications as well as augmented reality applications. Head mounted displays are often capable of supporting both virtual reality applications, where a user sees a digital image or environment which is different from the actual environment in which the user is located, and augmented reality applications. In the case of an augmented reality application the head mounted display supplements an image or objects being viewed that are present in the user's environment with additional content, e.g., information or images of objects which are not in the user's actual environment, but which are made visible to the user while the user views objects in the user's actual environment.

Augmented reality devices can be implemented as see through devices where a user views the actual environment through a display which is used to display information or objects which the user can see while looking at the objects in the environment. Alternatively, an augmented reality device can be implemented in a fully digital manner with the user viewing captured images of the actual environment on the head mounted display along with the additional information or objects. A camera is often built into head mounted display devices which are intended to support virtual reality and/or augmented reality.

While head mounted display devices which are intended to support virtual reality and/or augmented reality often include one or more processors, the processors are often optimized for and/or used primary for combining or streaming content to be displayed. Beyond the processing related to rendering images there is often very limited processing power available in a head mounted display for other processing tasks.

In the case of augmented reality or the display of digital content, to provide a good experience, information or objects which are relevant and/or consistent with the actual environment or digital content being viewed by a user, should be displayed in a timely manner with the viewing of the objects in the actual environment or digital content being displayed to the user at a resolution which is similar to that of other content being viewed or in high enough resolution so that the objects added to an actual scene are not of such low resolution that they are distracting from the objects in the environment. Unfortunately, head mounted displays normally lack the processing ability to select and/or generate high definition content, e.g., content relevant to objects in the environment being viewed, relevant to digital content, e.g., movie, game or other digital content being displayed and/or the experience being sought by the user.

In view of the above, it should be appreciated that there is a need for methods and/or apparatus which allow a head mounted display device capable of supporting virtual reality and/or augmented reality applications to obtain high definition content which can be used to supplement objects being viewed and/or digital content being viewed in a timely manner while the content is still relevant to actual or virtual objects being viewed or the experience the user is seeking. It would be desirable if such methods and/or apparatus did not require a large amount of processing resources at the head mounted display to select, generate and/or obtain content, thereby allowing the processing capability of the head mounted to primarily be used for controlling and/or displaying image content as opposed to other processing activities such as object recognition and/or generation of supplemental content intended to augment the main digital content or scene being viewed.

### SUMMARY

Methods and apparatus for generating and/or supplying supplemental content intended to supplement and thereby augment a scene being viewed and/or digital content being viewed are described.

The methods and apparatus are well suited for a wide variety of applications including, for example, shopping or object viewing applications. For example, the methods and/or apparatus can be used to augment a shopping experience by displaying objects or items a user is interested in which are not currently available for viewing at a store or other location such as a car dealership. The item or object may be, for example, a piece of apparel such as a shirt or other clothing item at a store which is not available at the store in the color option the user is considering purchasing. The item might be, for example, a car with a particular configuration or set of options, including color options, that is not available for viewing at a dealership. In accordance with the invention a user device is provided with rendered image content including an item or items corresponding to, or relevant to, an object in the environment being viewed. In the case of a museum, the object might be an artifact or painting in the museum's collection which is not currently in a display case or wall location being viewed, e.g., due to restoration work or for other reasons. User color preference and/or item option preference is communicated in some embodiments, e.g., in cases where a user is considering a purchase, along with information about objects or content being viewed to an augmentation content server.

The augmentation content server generates an image content stream, e.g., an HD image content stream, e.g., including high fidelity AR content, which is supplied to the user device. In some embodiments the image content stream is displayed, e.g., as an image layer, on the display of the user device thereby supplementing the actual environment being viewed and/or digital content being viewed. Since the augmentation content server is responsible for supplying the HD image content, the processor of the user device is not burdened to perform the processing associated with having to generate the image content and can simply process and display the supplemental content, e.g., high fidelity AR content, provided by the augmentation content server.

Where the supplemental content is determined based on one or more objects detected in an environment, the task of object detection can be performed by an object recognition server to which the user device communicates one or more captured images which are then processed by the object recognition server. Information about objects detected by the object recognition server is communicated back to the user device and/or augmentation content server which then uses the recognized object information in some embodiments to identify and/or generate supplemental content relevant or corresponding to a detected object. In the case where detected object information is communicated from the object recognition server to the user device the user device normally forwards and/or otherwise communicates such information to the augmentation content server. In some cases, e.g., where the user device or a display device, e.g., a smart TV, being viewed by the user, is receiving and displaying digital content, e.g., a program, from a content server or other content source, the user device provides information about the digital content being displayed to the user, e.g., the program being displayed or about to be displayed, to the augmentation content server. The user device may, and sometimes does, also provide user preference information such as color and/or other information about objects the user is interested in.

The augmentation content server, when generating supplemental content for a user device, takes into consideration the objects that are in the user environment, e.g., detected objects, and/or objects in the digital content being displayed or objects appropriate for inclusion in the content being displayed. Color and/or other object preference information can be, and sometime is, used to by the augmentation content server to determine the color and/or features of an object whose image is to be included in the supplemental image content stream. For example, the supplemental image content server can generate an image of a car that the user of the user device might be interested in with the car being in the color, model or having an option package the user expressed interest in. In the case of apparel, the supplemental image content generated for a user device may be in the color the user of the device expressed interest in.

The augmentation content server is able to indicate in the supplemental image content stream the location at which objects are to be displayed. This allows, for example, a car in the color, model and/or with the option package a user is interested in, but which is not available in a car dealership, to be displayed to the user of the user device next to an actual car which is available at the car dealership. Similarly, a shirt or other piece of apparel can be displayed to a user while visiting a store in a color or with features which are not present in the item in the store. For example, a user can be provided with an image, allowing the user to view a company name or logo emboldened on a shirt, which does not include the company name or logo, allowing the user to decide if he should pay for the extra cost of custom embroidery on a piece of clothing the user is going to purchase at the store. While such embodiments are examples of augmented reality applications of the invention, the methods are equally well suited for virtual reality applications where the environment being displayed and/or viewed is fully synthetic, e.g., such as may be the case when the user visits and views a virtual store or virtual car dealership.

While a content server providing digital content to be viewed is generally described as a device, e.g., server, external to the user device, the content server providing content being viewed can be incorporated into the user device, incorporated into a display device, and/or located at the customer premises and need not be a server coupled to the user device by the Internet or some other network connection to a physically remote device outside the premises or physically distant from the environment where the user device is located.

The user device can take many forms depending on the embodiment but generally includes a display device allowing images, e.g., including AR images, to be displayed. The user device can be a head mounted display device, a handheld device with a display and/or a device in the form of a pair of glasses on which image can be displayed while the user views the environment through the display.

While various features have been discussed in the summary, all embodiments need not include the full set of features discussed in the summary. Numerous features, aspects and embodiments will be discussed in the detailed description which follows.

### BRIEF DESCRIPTION OF THE FIGURES

FIG. 1 illustrates an exemplary first view from a user device, e.g., a mixed reality (MR) head mounted display (HMD) device, which is synchronized to digital content being displayed on a TV, and an exemplary second view from the user device, said second view including additional augmented reality (AR) content corresponding to an image of an object which appeared on the TV, said second view generated in accordance with an exemplary method of the present invention.

FIG. 2 is a drawing of an exemplary signaling diagram illustrating an exemplary method, in accordance with an exemplary embodiment, of streaming of augmented reality content synchronized with physical display digital content.

FIG. 3 illustrates an exemplary first view from a user device, e.g., a mixed reality (MR) head mounted display (HMD) device, which includes a recognized physical object, and an exemplary second view from the user device, said second view including additional augmented reality (AR) content corresponding to the recognized physical object, said additional AR content being a near duplicate of the recognized physical object, said second view generated in accordance with an exemplary method of the present invention.

FIG. 4 is a drawing of an exemplary signaling diagram illustrating an exemplary method, in accordance with an exemplary embodiment, of streaming of augmented reality content synchronized with physical objects.

FIG. 5A is a drawing showing a first part of a flow chart showing an exemplary method implemented in accordance with an embodiment of the present invention.

FIG. 5B is a drawing showing a second part of a flow chart showing an exemplary method implemented in accordance with an embodiment of the present invention.

FIG. 5 shows how FIGS. 5A and 5B can be combined to form a complete flowchart of an exemplary method of providing an augmented mixed reality or virtual reality experience to a user in accordance with one exemplary embodiment.

FIG. 6 is a drawing of an exemplary user device, e.g., a compute and display device supporting augmented and/or mixed reality, e.g., a smartphone, lightweight AR glasses, a mixed reality (MR) head mounted display (HMD) or a virtual reality (VR) head mounted display (HMD) utilizing augmented reality (AR) passthrough, in accordance with an exemplary embodiment.

FIG. 7 is a drawing of an exemplary physical display device, e.g., a smart TV, or a display device such a TV or monitor including an embedded set-top-box, in accordance with an exemplary embodiment.

FIG. 8 is a drawing of an exemplary object recognition server in accordance with an exemplary embodiment.

FIG. 9 is a drawing of an exemplary augmentation content server, e.g., a render server, in accordance with an exemplary embodiment.

FIG. 10 is a drawing of an exemplary access point (AP), e.g., a WiFi AP, in accordance with an exemplary embodiment.

FIG. 11 is a drawing of an exemplary system in accordance with an exemplary embodiment.

### DETAILED DESCRIPTION

A method for synchronizing physical digital content with a mixed reality (MR) head-mounted display (HMD) and displaying relevant augmented reality (AR) content on the HMD is described. In a system where a MR HMD is synchronized to a physical display device such as a TV, the MR HMD device can report its position and surroundings to get a stream of high-fidelity holograms, e.g., as part of a supplemental video content stream, relevant to the synchronized content. In addition, in an augmented reality embodiment content relevant to an object in the environment of the user device can be generated and displayed in accordance with preference information corresponding to user. The generated and displayed object may have a color and/or features selected by the user and be similar to an object such as a car or piece of apparel in a store or dealership but which has the features of interest to the user which are not visible in the actual physical item in the store or dealership.

Various embodiments in accordance with the present invention, are directed to method and apparatus for synchronizing physical digital media with a mixed reality (MR) head-mounted display (HMD), which includes the streaming of high-fidelity augmented reality (AR) content to the MR HMD. In cases where lightweight augmented reality (AR) or MR HMDs may not be capable of rendering high fidelity holograms, a server located elsewhere with higher compute capabilities can be utilized to stream images to the HMD. In this case, the HMD sends position and environment data to the server so that the server can accurately render the image that should be displayed on the HMD.

One example is a user watching a car commercial while wearing a MR HMD in which the MR HMD is aware of the current commercial and prompts the user to stream a high-fidelity model of the car. The environment and position of the MR HMD is streamed to a server that then renders an accurate frame of the car in the user's environment. The AR model of the car can then be manipulated based on user input.

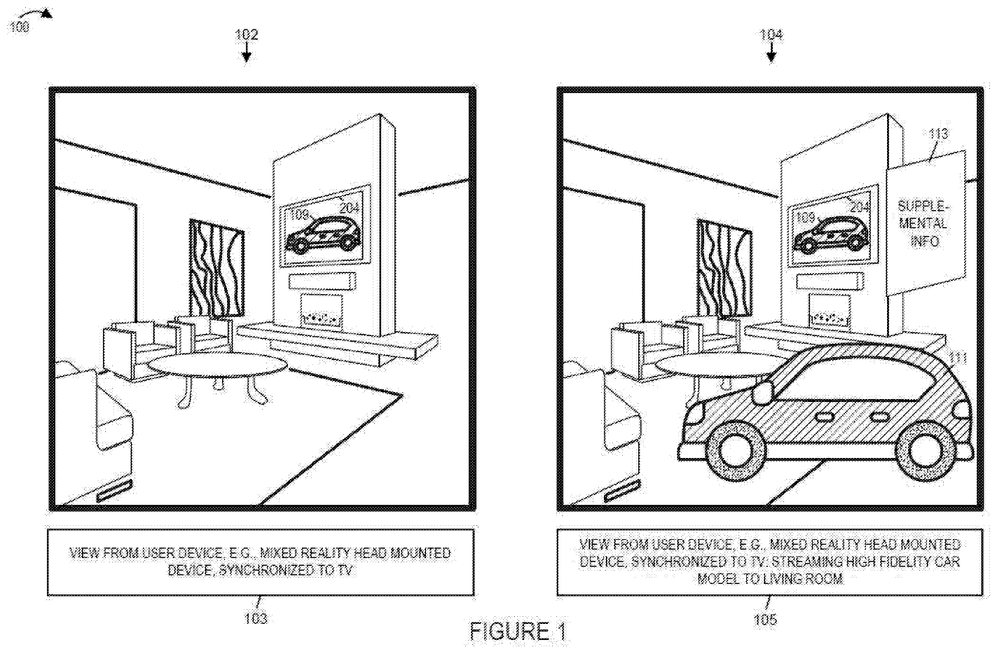

FIG. 1 is a drawing 100 which includes view 102 and view 104. View 102 is a first view from a user device, e.g., a mixed reality (MR) head mounted device (HMD), synchronized to a TV 204, as indicated by information block 103. View 102 is a living room view of a user, who is wearing the user device, e.g., the MR HMD, said living room including TV 204, on which a car commercial is being displayed, said car commercial including a car 109. View 104 is a second view from the user device, e.g., the mixed reality (MR) head mounted device, synchronized to TV 204, said view 104 including a view of a high fidelity car model 111 in the living room, as indicated by information block 105. View 104 further includes supplemental information 113 corresponding to the high fidelity car model 111.

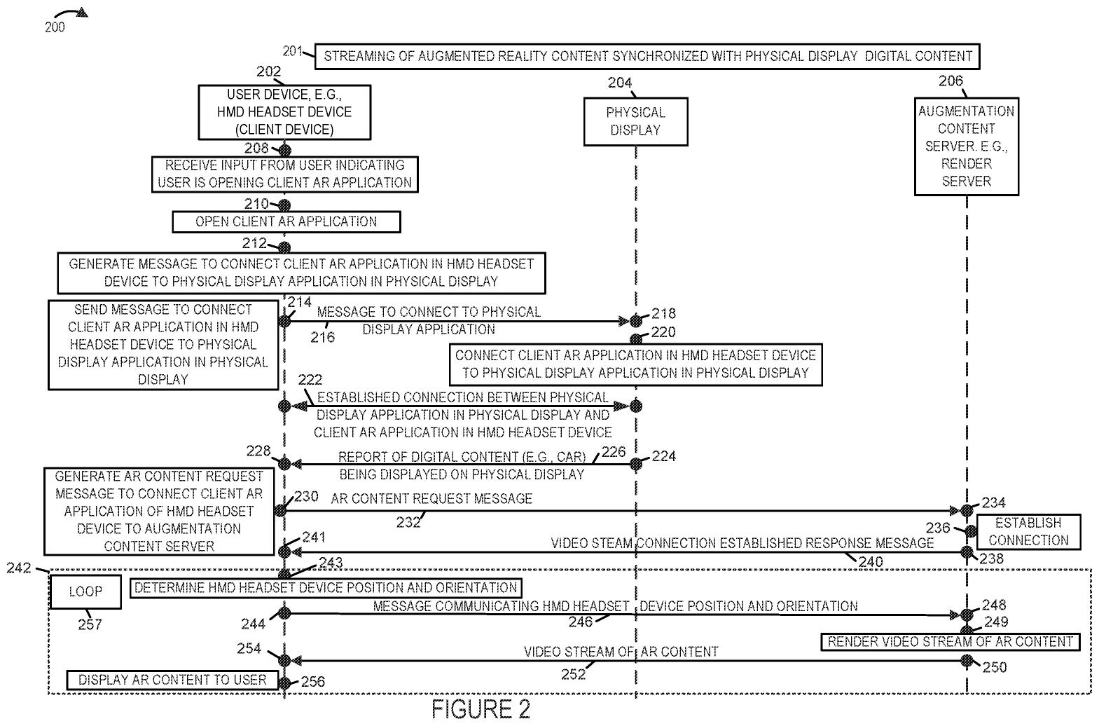

FIG. 2 is a drawing of an exemplary signaling diagram 200 illustrating an exemplary method, in accordance with an exemplary embodiment, of streaming of augmented reality content synchronized with physical display digital content, as indicated in title information block 201. Signaling diagram 200 includes user device 202, e.g., a HMD headset device, a physical display device 204, and an augmented content server 206, e.g., a render device. Physical display device 204 is, e.g., TV 107 of FIG. 1. User device 202, e.g., a HMD headset device, is, e.g., the user device, e.g., a MR HMD, corresponding to view 102 and view 104 of FIG. 1.

The user device 202 can be any computing device capable of augmented or mixed reality including a smartphone, lightweight AR glasses, a mixed reality head-mounted display, or a VR head-mounted display utilizing AR passthrough. These types of computing devices, which are augmented and/or mixed reality capable, are capable of viewing the real world, e.g., through transparent lenses or through a display showing a camera feed of the real world. These types of devices are able to render AR objects overlaid on top of a view of the real world.

In this exemplary embodiment, the user device 202, which is a client device, is synchronized to physical digital content. The physical digital content can be, and sometimes is, the form of a video or live broadcast being displayed on a physical display device 204, e.g., television or other type of monitor. The physical display device 204 is sometimes referred to as a physical digital content device. The client device 202 utilizes an application, e.g., a client device application, in which the user is signed into a service. The physical digital content device 204 will also be signed into an application, e.g., a display device application. This display device application is, e.g., running on a physical display device 204, e.g., a Smart TV, on a cable set-top box coupled to or included in physical display device 204, or on another display device capable of running applications. The physical digital content device 204, in some embodiments, acts as a server in which the client device 202 is informed by the server what digital content is currently playing on the physical device, e.g., TV display. When the digital content is changed, such as a channel being changed on a cable set-top box, the display device application would inform the client device 202. The client device 202 can then utilize content built into the client application to render AR objects within the user's environment. The AR objects would be relevant and synchronized to the digital content displayed on the physical device 204. AR objects can be as simple as supplementary information about the content being shown on the physical display 204 or more complex like high-fidelity digital twins of objects in which the user can interact with. Exemplary supplementary information includes, e.g., supplementary information 113 of FIG. 1, e.g., a list of features, specifications, and available selectable options corresponding to an image 109 of a car being viewed on physical display 204. An exemplary high fidelity digital twin of an object is, e.g., high fidelity car model 111 of FIG. 1, which corresponds to the car of car image 109.

AR client devices, such as user device 202, are limited by the local compute (CPU, GPU, memory) built into the device and are limited by power and heat factors. Because the user device 202 is a client device the terms phrases user device 202 and client device 202 may be and sometimes are used intercanal in the present application. Current AR client devices are often limited to rendering simple AR objects rather than high-fidelity objects that could be rendered by a desktop personal computer containing a graphics card (GPU). An advantageous feature of some embodiments, in accordance with the present invention, is that the need to store AR objects directly on the client device 202 to render locally has been eliminated, and instead the client device 202 connects to another compute server, referred to as an augmentation content server 206, e.g., a render server, that would stream a video stream containing high-fidelity AR content to the client device 202.

The augmentation content server 206, e.g., a render server, is, e.g., a server in a data center or a personal computer within a user's home or office. The augmentation content server 206, e.g., render server, has a compute capability, that is more capable of rendering high-fidelity content than the user's AR device 202. The AR client device 202 utilizes an application that is also connected to the augmentation content server 206, e.g., render server. The client application reports its local position according to the coordinate system maintained by the user device 202. This user device position includes details such as height from the floor and rotation of the user (client) device 202. The augmentation content server 206, e.g., render server, then utilizes the position details of the client to render a view of high-fidelity objects, e.g., a high fidelity car model, that are of the correct position and orientation relative to the client's current view. The rendering is sent to the client as part of a video stream that continually updates the render every frame, ensuring the AR objects are in the correct position.

The steps and signaling flow of exemplary signaling diagram 200 will now be described in more detail. User device 202 will be referred to as a HMD headset device in the description which follows; however, it should be appreciated that user device 202 may be, and sometimes is, another type of compute device having augmented and/or mixed reality capabilities.

In step 208, the HMD headset device 202 receives input from the user indicating that the user is sending input to open a client augmented reality (AR) application. In step 210, in response to the received user input, the HMD headset device 202 opens the client AR application. In step 212, the HMD headset device 202 generates and sends message 216, e.g., an application to application connection request message, to physical display device 204, said message 216 being a message to connect the client application in HMD headset device 202 to a physical display application in physical display device 204. In step 218, the physical display device 204 receives message 216, and in response in step 220, the physical display device 204 is operated to establish connection 222, e.g., a bi-directional connection, between the physical display application in the physical display device 204 and the client AR application in the HMD headset device 202.

In step 224, the physical display device 204 generates and sends, via established connection 222, a report 226 of digital content (e.g., a car) being currently displayed on physical display device 204. In step 228, the HMD headset device 202 receives the report 226 of digital content being displayed on physical device 204 and recovers the communicated information. In step 230, the HMD headset device 202 generates and sends an AR content request message 232 to augmentation content server 206. AR content request message 232 is a message to connect the client AR application of HMD headset device 202 to augmentation content server 206 and to request AR content, e.g., specific AR content. Message 232 includes a connection establishment request, ID information corresponding to HMD headset device 202, information, e.g., ID information, corresponding to the site at which the HMD headset device 202 is currently located, and information identifying the digital content (e.g., information identifying a set of digital content corresponding to a car in a commercial being displayed) based on information from received report 226. In step 234, the augmentation content server 206 receives the AR connect request message 232 and recovers the communicated information. In step 236, the augmentation content server 206 establishes a connection with the client AR application of HMD headset device 202. In step 238, the augmentation content server 206 generates and sends video stream connection established response message 240 to the client AR application of the HMD headset device 202, which in step 241 receives message 240, recovers the communicated information, and recognizes that a connection has been established to stream AR content to HMD headset device 202.

In step 243 the HMD headset device 202 determines, e.g., using its cameras, accelerometers, gyroscopes, and knowledge of the environment in which it is located including, e.g., reference information, current HMD headset device position and orientation. In step 244, the HMD headset device 202 generates and sends a message 246, communicating HMD headset device position and orientation, to augmentation content server 206. In step 248, the augmentation content server 206 receives message 246 and recovers the communicated HMD headset device position and orientation information. In step 249, the augmentation content server 206 renders, using retrieved stored information corresponding to the AR content request and the most recently received HMD headset device position and orientation information, a video stream of AR content, e.g., AR content for a high fidelity car model to be displayed. In step 250 the augmentation content server 206 generates and sends video steam 252 of AR content to the AR client application of the HMD headset device 202. In step 254, the HMD headset device 202 receives the video stream 250 of AR content and recovers the communicated information. In step 256 the HMD headset device 202 displays the AR content recovered from the video stream 252 to the user of the HMD headset device 202, e.g., the user of HMD headset device now views high fidelity AR content within the field of view, e.g., car model 111 is viewed by the user of HMD headset device 202, as shown in view 104 of FIG. 1. In some embodiments, a set of supplemental information, e.g., supplemental information 113, may be, and sometimes is, also be viewed within the field of view of the user of HMD headset device 202, e.g., with the augmentation content server also including the supplemental information 113 in video stream of AR content.

Information box 257, indicates that the steps and signaling within dotted box 241 are performed on a recurring basis multiple times, with the method looping through sequence of steps (243, 244, 248, 249, 250, 254, 256).

A method for recognizing physical objects with a mixed reality (MR) head-mounted display (HMD) and streaming of relevant high-fidelity content is described. In a system where a MR HMD is able to recognize physical objects (either via local compute or via uploading of camera feed for recognition by a server), the MR device can report its position and surroundings to get a stream of high-fidelity holograms relevant to the physical object.

Various embodiments, in accordance with the present invention, are directed to methods and apparatus for offloading of camera frames, e.g., obtained from camera of a MR HMD device, to perform object recognition, and subsequent streaming of high-fidelity content (AR content) relevant to a recognized object to the MR HMD to be display by the MR HMD.

A physical can object can be identified by local object recognition, server assisted object recognition, e.g., streaming a camera feed to a server, in which the server can process the images in an object recognition machine learning model and identify an object, or manually via user input.

Once a MR HMD device has identified a physical object, the MR HMD device can utilize local compute to provide basic information and assets relevant to the object. Utilization of streaming from a server enables higher fidelity assets such as digital twins that match the lighting of the environment. One example is a car that has been recognized by make, model, year, and trim. The HMD can then stream a digital twin to render next to the existing car. With the AR digital twin, any digital manipulation techniques can be, and sometimes are, utilized such as changing features (paint color, interior type, trim).

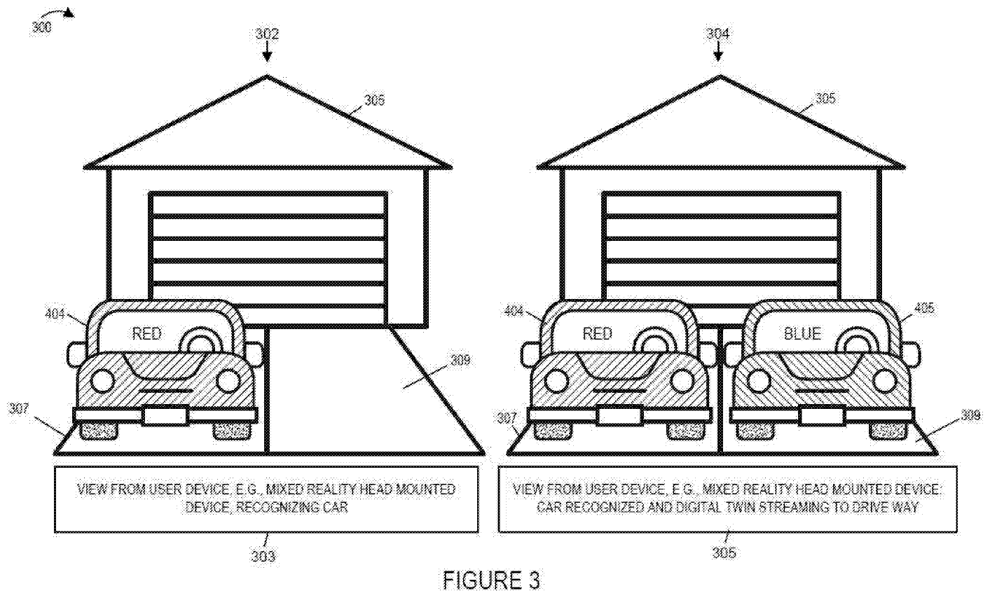

FIG. 3 is a drawing 300 which includes view 302 and view 304. View 302 is a first view from a user device, e.g., a mixed reality (MR) head mounted device (HMD) recognizing a car 404, as indicated by information block 303. View 302 is an outside view of a user, who is wearing the user device, e.g., the MR HMD, said outside view 302 including a two car garage 305, a first side driveway 307, a second side driveway 309, and a car 404 located in the first side driveway 307. In this example, the car 404 is a red car of a particular make, model and model year. The make, model and model year of the car are recognized, e.g., in accordance with the method of the present invention. View 304 is a second view from the user device, e.g., the mixed reality (MR) head mounted device, said second view 304 including the recognized car 404 and further including a digital twin 405 of recognized car 404, as indicated by information block 405. View 402 is an outside view of the user, who is wearing the user device, e.g., the MR HMD, said outside view 402 including the two car garage 305, a first side driveway 307, a second side driveway 309, recognized car 404 located in the first side driveway 307, and AR digital twin car 405 located in the second side driveway 309. In this example, AR digital twin car is the same make, model and year of real recognized car 404; however, the color of real car 404 is red, while the color or digital twin care 405 is blue.

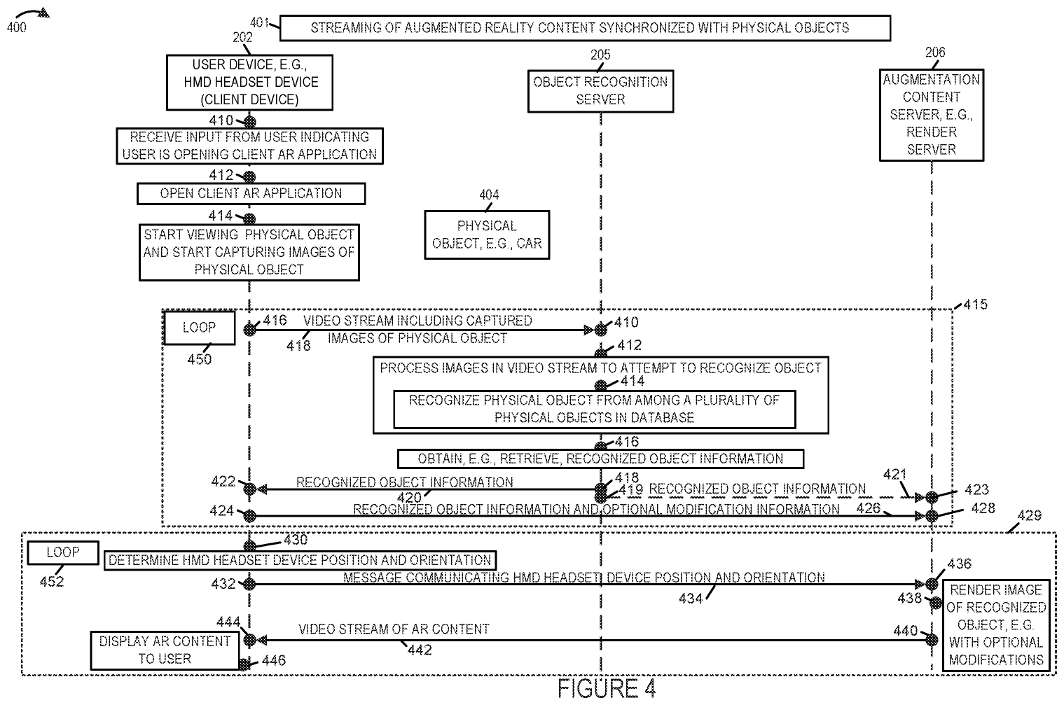

FIG. 4 is a drawing of an exemplary signaling diagram 400 illustrating an exemplary method, in accordance with an exemplary embodiment, of streaming of augmented reality content synchronized with physical objects, as indicated in title information block 401. Signaling diagram 400 includes user device 202, e.g., a HMD headset device, a physical object 404, e.g., a car, an object recognition server 205, and an augmented content server 206, e.g., a render device. Physical device 404, e.g., a car, is, e.g., red car 404 of FIG. 1. User device 202, e.g., a HMD headset device, is, e.g., the user device, e.g., a MR HMD, corresponding to view 302 and view 304 of FIG. 3.

The user device 202 can be any computing device capable of augmented or mixed reality including a smartphone, lightweight AR glasses, a mixed reality head-mounted display, or a VR head-mounted display utilizing AR passthrough. These types of computing devices, which ae augmented and/or mixed reality capable, are capable of viewing the real world (through transparent lenses or through a display showing a camera feed of the real world). These types of devices are able to render AR objects overlaid on top of a view of the real world.

In this exemplary embodiment, user device 202, which is a client device, utilizes built-in cameras to gather video of the real-world environment and objects. Specifically, the client device 202 includes an application that attempts to recognize objects being looked at by the user. Once a real-world object is recognized, supplementary information and/or AR models are rendered by a augmentation content server, e.g., a render server and streamed to the client device 202 for display.

AR client devices, such as user device 202, are limited by the local compute (CPU, GPU, memory) built into the device and are limited by power and heat factors. Current methods for object recognition in AR devices typically rely on high end compute within the AR device to recognize objects quickly. An advantageous feature of some embodiments, in accordance with the present invention is that the need to process the video stream of the client device locally has been eliminated, and instead the client device 202 connects to another compute server, e.g., object recognition server 205, that would ingest the client's video stream and run object recognition. Object recognition takes a video stream and attempts to locate a bounding box around objects that are recognized. This often relies on using a deep learning model that has been trained on what common objects look like. The frames of the video stream are then used with these pre-trained models to infer what objects are visible in the video. This process often relies on a powerful GPU to accurately recognize objects in real time quickly. AR client devices, such as user device 202, will usually always have lower power compute than what can run on a standalone computer or server, such as object recognition server 205.

Once the object recognition server 205 recognizes the object(s) in the real world, this information is sent to the client device 202. The client device 202, in some embodiments, renders supplementary information and/or AR models relevant to the recognized object. For example, a user of user device 202, e.g., a HMD headset device, located at a car dealership can have the exact make, model, and year of a car recognized, e.g. by remotely located object recognition server, and have supplementary information overlaid such as cost, MPG, and safety rating of the car. Options that are not available to be seen at the dealership can be overlaid on the existing real-world car. A digital twin of the exact car can be rendered next to the real-world car and then be interacted with such as changing the color or options.

Just as the object recognition can be, and sometimes is, off-loaded to a server, e.g., object recognition server 205, some embodiments of the present invention, include the feature of off-loading the rendering to a server, e.g., augmentation content server 206, e.g., a render server, to ensure high-fidelity AR objects can be rendered. Current user devices, e.g., current HMD headset devices, are often limited to rendering simple AR objects rather than high-fidelity objects that could be rendered by a desktop personal computer containing a graphics card (GPU). An advantageous feature of some embodiments, in accordance with the present invention is that the need to render AR objects locally is eliminated, and instead the client device 202 connects to another compute server, e.g., augmentation content server 206, that streams a video stream containing high-fidelity AR content to client device 202.

The augmentation content server 206, e.g., a render server, is, e.g., a server located in a data center or a personal computer located within a user's home or office or business site. In some embodiments, the same physical server that runs the object recognition operations also runs content augmentation, e.g., rendering, operations. In some other embodiments separate servers are used, e.g., objection recognition server 205 is a different server than augmentation content server 206, e.g., a render server. The augmentation server 206, e.g., a render server, has a compute capability that is more capable of rendering high-fidelity content than the user's AR device 202. The AR client device 202 utilizes an application that is also connected to the augmentation content server 206, e.g., a render server. The client application included in user device 202 reports its local position according to the coordinate system maintained by the user device 202. This position includes details such as height from the floor and rotation of the user (client) device 202. The augmentation content server 206, e.g., a render server, then utilizes the position details of the client to render a view of high-fidelity objects that are of the correct position and orientation relative to the client's current view. The rendering is sent to the client as part of a video stream that continually updates the render every frame, ensuring the AR objects are in the correct position. The steps and signaling flow of exemplary signaling diagram 400 will now be described in more detail. User device 402 will be referred to as a HMD headset device in the description which follows; however, it should be appreciated that user device 202 may be, and sometimes is, another type of compute device having augmented and/or mixed reality capabilities.

In step 410, the HMD headset device 202 receives input from the user indicating that the user is sending input to open a client augmented reality (AR) application. In step 412, in response to the received user input, the HMD headset device 202 opens the client AR application.

In step 414, the HMD headset device 202 starts viewing a physical object, e.g., car 404, and starts capturing images including the physical object.

In step 416, HMD headset device 202 sends video stream 416 including captured images of the physical object 404, to object recognition server 205, which receives the video stream 418 in step 410. In step 412 the object recognition server processes images in the video stream to attempt to recognize objects. Step 412 includes step 414, in which the object recognition server recognizes physical object 404 from among a plurality of physical objects in the database. For example, the object recognition server 205 recognizes that object 404 is a car of a specific manufacture, specific model, specific body style and specific build year.

In step 416, the object recognition server 205 obtains, e.g., retrieves, recognized object information, e.g., from one or more database storing information corresponding to the detected object, e.g., vehicle databases containing images, model information, specification information, option information, etc., corresponding to the identified car 404 of a specific manufacturer company, specific model, specific body type and specific build year. In step 418 the object recognition server 205 communicates recognized object information 420 to HMD headset device 202, which receives the information 420 in step 422. In step 424, the HMD headset device sends recognized object information 426 to augmentation content server 206, which receives the information in step 428. In some embodiments, recognized object information 426 is a subset of the recognized object information 420. For example, recognized object information 420 includes information which can be used to generate an AR model of car 404 and additional option information indicating possible user selectable variations to car 404, e.g., different color paints, different trim levels, etc., and recognized object information includes information which can be used to generate an AR model of car 404, and information indicating a different color for the AR model 405 of the car, e.g., change the exterior color from red to blue.

In some embodiments, the object recognition server also sends, in step 419 recognized object information 421 directly to the augmentation content server 206, which receives the information in step 423. In some such embodiments, different sets of information are typically sent by the object recognition server 205 to the HMD headset device 202 and to the augmentation content server 206, e.g., information used to generate a basic car model AR image is sent to augmentation content server 206, and information indicating user selectable options is sent to HMD headset device 202, which subsequently performs option selection, e.g., new paint color of blue to be used in AR car 405, and communicates its selection(s) to the augmentation content server 206, to be used in the rendering.

In step 430 the HMD headset device 202 determines, e.g., using its cameras, accelerometers, gyroscopes, and knowledge of the environment in which it is located including, e.g., reference information, current HMD headset device position and orientation. In step 432, the HMD headset device 202 generates and sends a message 434, communicating HMD headset device position and orientation, to augmentation content server 206. In step 436, the augmentation content server 206 receives message 432 and recovers the communicated HMD headset device position and orientation information.

In step 438 the augmentation content server 206 renders, using received recognized object information and optional modification information 426 and/or received recognized objection information 421, and the most recently received HMD headset device position and orientation information 432, an image of the recognized object e.g., with optional modifications. For example, in step 436 the augmentation content server 206 renders a high fidelity image of recognized red car 404 with the color being changed to blue. In step 440, the augmentation content server 206 generates and sends video stream 442 of AR content, e.g., including the blue car which is a twin of the original red car (object) 405. In step 444 the HMD headset device 202 receives the video stream of the AR content 442, and in step 446 the HMD headset device 202 displays the AR content to the user of HMD headset device 202.

Information box 450 indicates that the steps and signaling within dotted box 415 are performed on a recurring basis multiple times, with the method looping through sequence of steps (416, 410, 412, 414, 416, 418, 422, 424, 428).

Information box 452 indicates that the steps and signaling within dotted box 429 are performed on a recurring basis multiple times, with the method looping through sequence of steps (430, 432, 436, 438, 440, 444, 446).

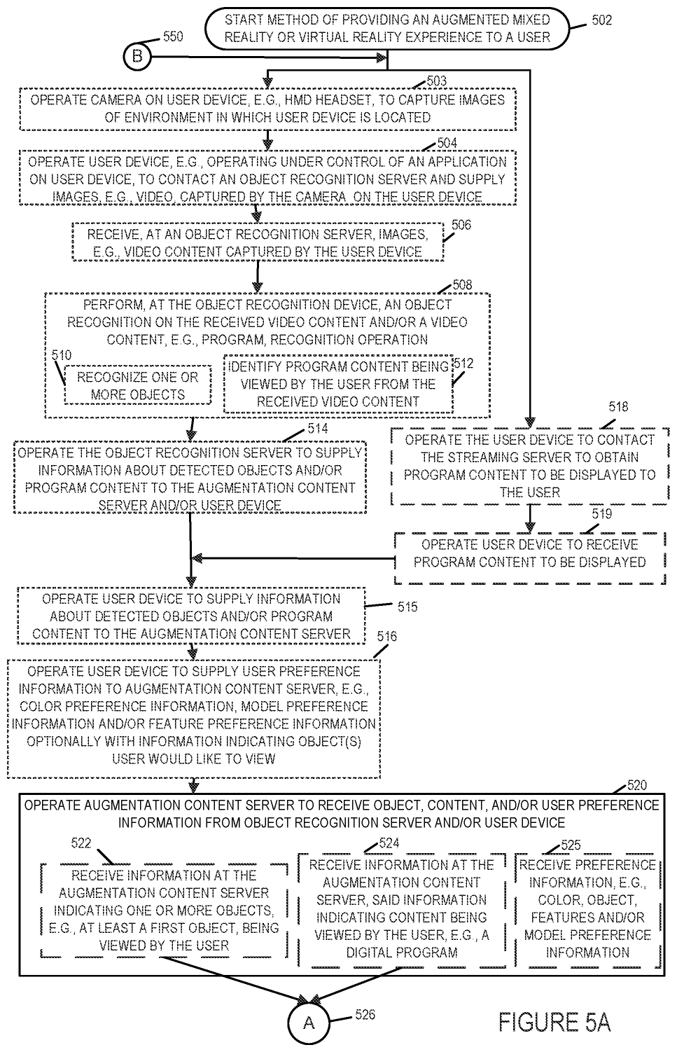

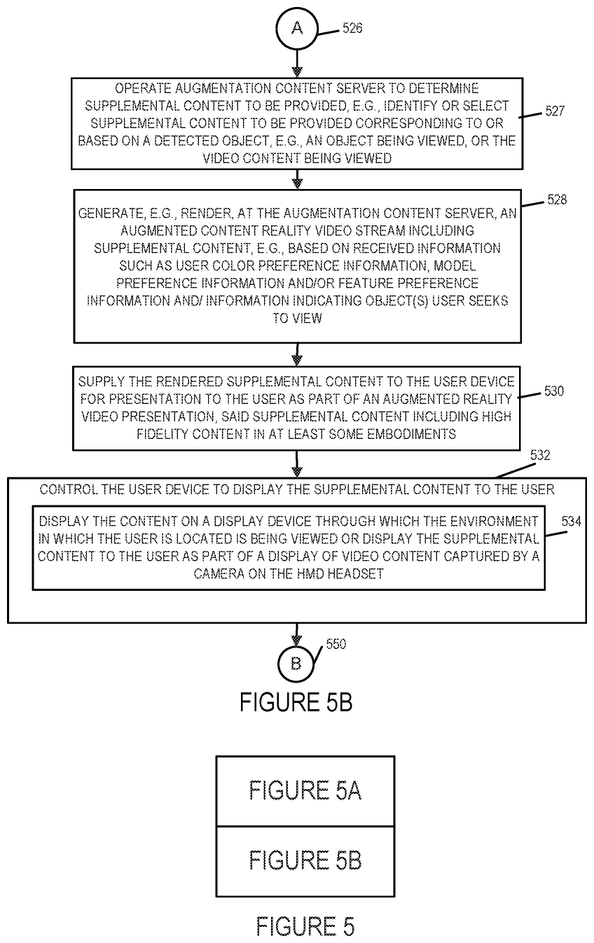

An exemplary method implemented in accordance with an embodiment of the invention will now be discussed with reference to FIG. 5, which comprises the combination of FIGS. 5A and 5B.

FIG. 5 illustrates a method 500 implemented in accordance with one exemplary embodiment of the present invention. The method 500 begins in start step 502 with one or more of the devices used to implement the method, such as a user device 202 or 600 capable of supporting mixed reality and/or virtual reality operations being powered on. For purposes of explaining the exemplary method the method will be described using the example where the user device is a HMD headset device but it should be appreciated that the method is not limited to such devices and can be implement with a wide range of user devices including augmented reality glasses, cell phones and/or other devices.

The method 500 can be used to support augmented reality applications and/or virtual reality applications. Depending on whether an AR/VR mode of operation is being used at a given time, processing can proceed from start step 502 to step 503 and/or to step 516. Thus, it should be appreciated that there are multiple paths from step 502 which can be performed in parallel and/or asynchronously before the method reaches step 515 which will be discussed below.

In FIG. 5 dashed lines around boxes are used to indicate steps performed in some but not all embodiments. For example, steps 503, 504, 506, and 508 relate to an embodiment where a camera 661, e.g., included in the user device 202, is used to capture images and an object recognition server 205 is then used to identify objects or program content in one or more of the captured images. In the case of a virtual reality embodiment and/or application where the user is presented with a completely virtual environment based on digital content provided to the user device, in some but not all cases, steps 504, 506, 508, and 508 are skipped.

In step 503 a camera 661 on the user device 202, 600 is operated to capture images, e.g., video, of the environment in which the user device is located. For example, the camera may capture images of a store where the user is using the user device 202, a car dealership where the user is visiting and/or a portion of the user's home where a television 204 or other display device is displaying a program or other content within view of the user and thus within the image capture area of the camera 661 on the user device 202. The captured images will include images of objects in the environment in which the user is using the user device 202.

Operation proceeds from step 503 to step 504 in which the user device 202, operating in some embodiments under control of an application 680 running on the user device 202, supplies one or more captured images, e.g., captured video, to the object recognition device, e.g., object recognition server 205.

In step 506 the object recognition server 205 receives the video content captured by the user device including one or more images of the environment in which the user device 202 is located. Then, in step 508 the object recognition device performs an object and/or program content recognition operation on one or more of the received images. The object recognition operation will detect one or more objects in the received images, e.g., objects visible to the user at the location where the user is using the user device 202. In some cases, where a program is being displayed, e.g., on a display of a TV set 204, objects in the displayed program will be detected. The object recognition server 205 may and sometime does detect program content being viewed by the user based on detection of a program, e.g., being displayed on the TV set 204, in the video received from the user device 202. Thus step 506 in some embodiments includes step 510 in which one or more objects are recognized in the images received from the user device 202 and in some embodiments will include step 512 in which program content being viewed by the user of the user device is identified.

With objects and/or program content having been identified in step 508 operation proceeds to step 514 in which information about the identified objects and/or program content is communicated to the user device 202 and/or augmentation content server 206. When information is supplied to the augmentation content server 206 directly from the object recognition server 205 the information is supplied with information identifying the user device 202 to which the detected objects/program content corresponds so that the augmentation content server 206 knows which particular user device 202 it should send supplemental content corresponding to the detected objects/program content. Operation proceeds from step 514 to step 515.

Operation can and also does, in some embodiments, proceed from step 502 to step 515 via steps 518 and 519. In step 518 which is performed in virtual reality embodiments and some mixed reality embodiments, the user device 202 requests content from the content server, e.g., program content server 1114 which is then received in step 519 by the user device 202 and displayed to the user. Operation proceeds from step 519 to step 514.

In many cases, the user device 202, sends and receives information to and from the object recognition server 205 and augmentation content server 206. In such an embodiment the user device 202 will provide information about detected objects and/or program content, received from the object recognition server 205 and/or program content server 1114, to the augmentation content server 206. In step 516, the user device 202 communicates user preference information to the augmentation content server 206. The preference information may and sometimes does indicate user preferences for a particular color, object or item. Preference information may and sometimes does include model preference information indicating which model of an item, such as a car, the user is interested in or prefers to receive information about, and/or feature preference information indicating, for example particular features which the user would like to see on an object or item the user is interested in, e.g., considering purchasing. Items/objects for which preference information may be provided could be such things as cars which might be purchased, apparel items such as shirts or other clothing items and/or even art works which the user might want to view, such as a particular painting by an artist identified by the user, but which are not physically present at a location such as a museum where the user is located but which are part of the museum's collection. Features identified in the user preference information might include such things as the set of car features or options the user would like to see in a car which might be purchased and/or in the case of apparel a logo or name that can be embroidered on the piece of clothing under consideration, e.g., as an add on option. The color information can be used to control the color of the car or item, e.g., shirt or other piece of clothing, which will be shown to the user but which, in some cases, is not physically available at the location of the user of the user device 202.

Operation proceeds form step 516 to step 520. In step 520 the augmentation content server 206 receives object, content and/or user preference information. Object recognition server 205 and/or user device 202 may supply various pieces of the information to the augmentation content server 205 but in some embodiments the information is communicated from the user device 202 to the augmentation content server 205 in one or more different messages. Step 520 may include multiple sub-steps 522, 524 and 525 with various pieces of information being received at different times and/or from different devices in different sub-steps. However, in some embodiments the user device 202 communicates all of the information listed in step 520 in a single supplemental content request message sent by the user device 202 to the augmentation content server 206 which is then received in step 517.

In sub-step 522 of step 520 the augmentation content server 206 receives information indicating one or more objects detected in an image or images captured by the user device 202. The detected object information received in step 522 identifies at least a first object which is visible in the environment in which the user device 202 is used. In sub-step 524 of step 520 the augmentation content server 206 receives information indicating content being viewed by the user, e.g., a digital program. This information can be known based on which content the user device requested in the request for content made in step 518 or based on detection of a program by the object recognition server 205. In sub-step 525 of step 520 the augmentation content server 206 receives preference information communicated by the user device, e.g., the information discussed with respect to step 516. Some or all of sub-steps 522, 524, 525 are performed as part of step 520 depending on the particular embodiment and/or whether the user is operating the user device 202 as an AR device or VR device at a given point in time.

Operation proceeds from step 520 of FIG. 5A to step 527 of FIG. 5B via connecting node A 526.

In step 527 the augmentation content server 206 determines, e.g., identifies or selects, supplemental content to be provided to the user device. In some embodiments the determined supplemental content corresponds to, or is based on, a detected object, e.g., an object being viewed, or corresponding to content being displayed, e.g., a portion of the digital program content being displayed on the user device 202 or on a display device 204 in the environment in which the user device 202 is located. For example, it may be determined in step 527 that a car or piece of apparel which corresponds to one which is detected in the user environment should be selected for display but with the displayed version being in accordance with the user's preferences. Then in step 528 the augmentation content server 206 generates the supplemental content, e.g., an image or set of images which step 527 determined should be provided. As part of supplemental content generation step 528 the augmentation content server 206 can and sometimes does generate high fidelity image content based on head position and/or other information received from the user device 202, e.g., head mounted display. In some embodiments such head position information is received from the user device at the augmentation content server along with user preference information. The rendered supplemental image content in many embodiments includes HD (high definition) image content, e.g., 1080p 4K image content in some but not all embodiments. The rendered supplemental image content maybe and sometimes is in the form of a video content stream communicating a video layer than can be easily combined with other digital image content, e.g., program content layers, and/or displayed as part of a virtual or mixed reality application implemented by the user device 220.

In generating the supplemental image content in step 528 the augmentation content server normally takes into consideration the received preference information. Thus, in step 528 the augmentation content server 206 will frequently generate an image of an object such as a car or piece of apparel, in accordance with one or more of the user preferences. For example, an image of a car which has the color indicated by received color preference information and is of a model type indicated by user preference information is sometimes generated in step 528. The generated object of the car may also correspond to a car of the indicated model type with a set of features or options (e.g., a car option package) the user of the user device indicated interest in. In the case of apparel, a shirt or pair of pants for example, an image of the clothing item in the color indicated to be preferred by the user may be generated in step 528. The generated image of the piece of clothing may include a company logo or name indicated in the user preference information shown embroidered on the clothing item, e.g., in response to the user indicating a preference for such an embroidery option.

With the supplemental image content having been generated in step 528 by the augmentation content server 206, operation proceeds to step 530 in which the supplemental image content is communicated, e.g., supplied via the Internet or another network connection, to the user device.

With the user device 202 having been supplied with the supplemental content, operation proceeds to step 532 in which the user device is controlled to display the supplemental content to a user of the user device 202. In step 530 the supplemental content in some cases is displayed with digital program content on display 666. Some such embodiments are virtual reality embodiments. However, other embodiments are augmented or mixed reality embodiments.

In some embodiments step 532 includes step 534 which relates to an augmented reality embodiment where the user device 202 displays the supplemental image content on a display 666 through which the environment in which the user is located is being viewed or the supplemental content is displayed as part of a display of video content captured by the camera 661 of the user device 220.

In some embodiments, e.g., in virtual reality embodiments, step 532 includes operating the user device to generate one or more composite images or pictures by combining one or more layers of digital program content, e.g., images of a video sequence, with the supplemental image content to be displayed. In such a case the digital program content and supplemental image content can be treated as separate layers which are combined to generate a displayed image. Alpha blending is sometimes used to combine the layers. The final displayed image can include the multiple layers accurately combined, e.g., with the supplemental content in some cases appearing as the top layer and obscuring portions of the digital program content which is treated as a lower image layer. Some experts refer to this process or portion of displaying an image as the “final render” with this phrase being typically associated with 3D image rendering such as may be implemented by a virtual or mixed reality application such as the ones implemented by the user device 202 in some embodiments. The combining is a relatively simply processing operation as compared to the supplemental image content generation operation which involves generating images of object with a perspective that maybe and sometime is based on the orientation of a head mounted display or where a user is looking as may be and sometimes is communicated from the user device 202 to the augmentation content server 206.

The process of FIGS. 5A and 5B can be performed on an ongoing basis as a user moves through an environment and/or watches digital program content. Accordingly, operation is shown proceeding from step 532 back to step 503 and/or 518 via connecting node B 550.

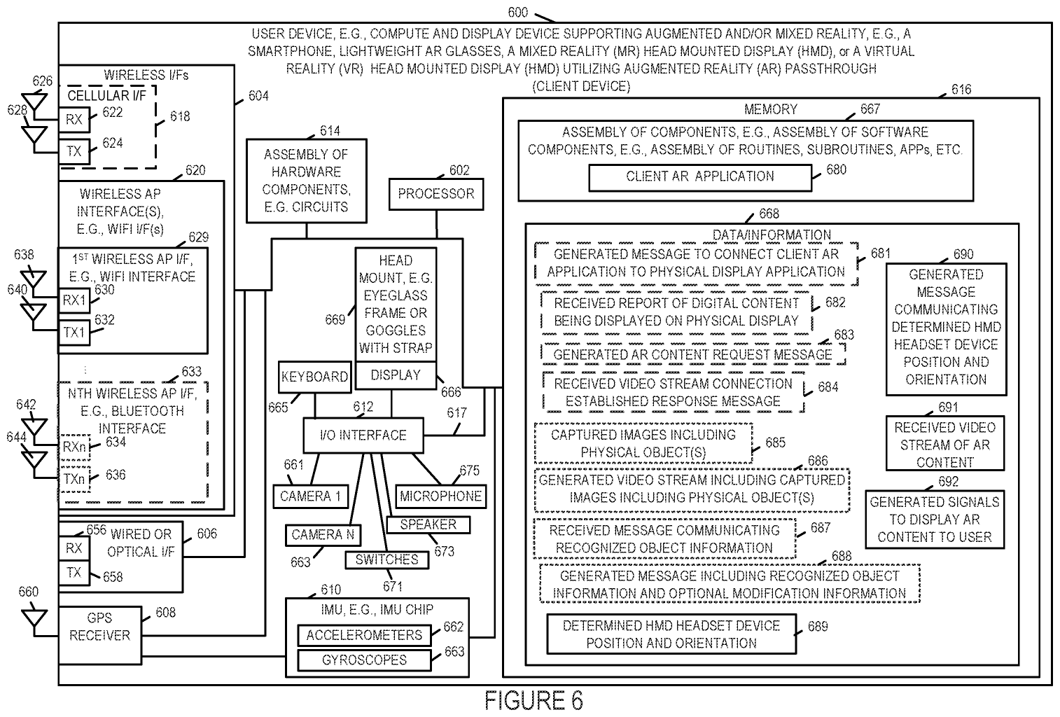

An exemplary user device 600 which can be used as the suer device 202 or any other user device discussed herein will now be discussed with reference to FIG. 6.

FIG. 6 is a drawing of an exemplary user device 600, e.g., a compute and display device supporting augmented and/or mixed reality, e.g., a smartphone, lightweight AR glasses, a mixed reality (MR) head mounted display (HMD) or a virtual reality (VR) head mounted display (HMD) utilizing augmented reality (AR) passthrough, in accordance with an exemplary embodiment. Exemplary user device 600 is, e.g., user device 202, e.g., a HMD headset device of FIG. 2 or FIG. 4, the user device, e.g., MR HMD, corresponding to views 102, 104 of FIG. 1 or views 302, 304 of FIG. 3, and/or the HMD headset of the flowchart of FIG. 5.

Exemplary user device 600 includes a processor 602, e.g., a CPU, wireless interfaces (I/Fs) 604, a wired or optical interface 606, a GPS receiver 608, inertial measurement unit (IMU) 610 including accelerometers 662 and gyroscopes 663, I/O interface 612, assembly of hardware components 614, e.g., circuits, and memory 616, coupled together via a bus 617 over which the various elements may interchange data and information.

Wireless interfaces 604 includes a cellular wireless interface 618 and wireless access point (AP) interface(s) 620. Cellular wireless interface 618, e.g., a 3GPP 5G cellular interface, includes wireless receiver 622 and wireless transmitter 624. Wireless receiver 622 is coupled to receive antenna 626, via which the user device 600 receives wireless signals from cellular base stations. Wireless transmitter 622 is coupled to transmit antenna 628, via which the user device 600 transmits wireless signals to cellular base stations.

Wireless AP interfaces 620 includes one or more wireless AP interfaces (1st wireless AP interface 629, e.g., a WiFi interface, . . . . Nth wireless AP interface 633, e.g., a Bluetooth interface). 1st wireless interface 629 includes wireless receiver 630 and wireless transmitter 632. Wireless receiver 630 is coupled to receive antenna 638, via which the user device 600 receives wireless signals, e.g., WiFi wireless signals, from APs, e.g., WiFi APs. Wireless transmitter 632 is coupled to transmit antenna 640, via which the user device 600 transmits wireless signals, e.g., WiFi wireless signals, to APs, e.g., WiFi APs. Nth wireless interface 633 includes wireless receiver 634 and wireless transmitter 636. Wireless receiver 634 is coupled to receive antenna 642, via which the user device 600 receives wireless signals, e.g., Bluetooth wireless signals, from APs, e.g., Bluetooth APs. Wireless transmitter 636 is coupled to transmit antenna 644, via which the user device 600 transmits wireless signals, e.g., Bluetooth wireless signals, to APs, e.g., Bluetooth APs.

Wired or optical interface 606 includes receiver 656 and transmitter 658. Wired or optical interfaces couples user device 600 to a wire cable or fiber optical link and to a local network, a cable network and/or the Internet, when user device is at a location where such a connection is available and the user of user device 600 decides to use the wire or optical connection, e.g., the user of user device 600 is stationary or can operate tethered to a landline connection, which is available.

GPS receiver 608 is coupled to GPS antenna 660 via which the user device receives GPS signals from GPS satellites. The GPS receiver 608 determines time, position, velocity information, altitude information, heading information, and in some cases, navigation information based on the received and processed GPS signals. The GPS receiver 608 is coupled to IMU 610, e.g., an IMU chip, which determines and outputs changes in velocities and changes in orientation over time. In some embodiments, the GPS receiver 608 receives information from IMU 610, which is used to aid the GPS receiver 608, e.g., GPS reception is unavailable or of low quality. In some embodiments, the user device processes information from both the IMU 610 and the GPS receiver 608, when available to determine the position and orientation of the user device 600. In some embodiments, processed images from the cameras (camera 1 661, . . . , camera N 663) are also used in addition to stored reference information corresponding to an environment in determining position and orientation of the user device. In some embodiments, user input as part of an initialization process is used to initialize a location and orientation for the user device, and user device 600 position and orientation are updated over time using IMU data and/or GPS data.

User device 600 further includes a plurality of I/O devices (keyboard 664, display 666, microphone 675, speakere 673, switches 671, and cameras (camera 1 661, . . . , camera N 663) coupled to I/O interface, which couples the various I/O devices to bus 617 and to other components within user device 600. Display 666, e.g., a MR or VR HMD supporting AR, is attached to a head mount 669, e.g., an eyeglass frame or googles with strap. Cameras (661, 663) capture images, e.g., images including objects which may be detected, and from which AR content may be generated.

Memory 616 includes an assembly of components 667, e.g., an assembly of software components, e.g., an assembly of routines, subroutines, APPs, etc., and data/information 668.

Assembly of software components 667 includes machine executable instructions, which when executed by processor 602 control the user device 600 to perform steps of an exemplary method in accordance with the present invention, e.g., steps of the method of signaling diagram 200 of FIG. 2 and/or steps of the signaling diagram 400 of FIG. 4 and/or steps of the exemplary method of the flowchart of Figure which are performed by a user device, e.g. user device 202.

Assembly of components 667 includes a client AR application 680, which performs various operations related to AR, e.g., connection establishment, communication of messages, communication of streams, etc., with devices, e.g., display device 204, and/or various servers, e.g., object recognition server 205, and augmentation content server 206.

Data/information 668 includes a generated message 681 to connect the client AR application to a physical device display application, a received report 682 of digital content being display on the physical display, a generated AR content request message 683 to be sent to a augmentation content server, a received video stream connection established response message 684, captured images 685 including physical object(s), a generated video stream 686 including captured images including physical object(s) to be sent to an object recognition server, a received message 687 communicating recognized object information, a generated message 688 including recognized object information and optional modification information to be sent to an augmentation content server, determined HMD headset position and orientation 698, a generated message 690 communicating determined HMD headset position and orientation to be sent to the augmentation content server, a received video stream of AR content 691, and generated signals 692 to display the received AR content to the user.

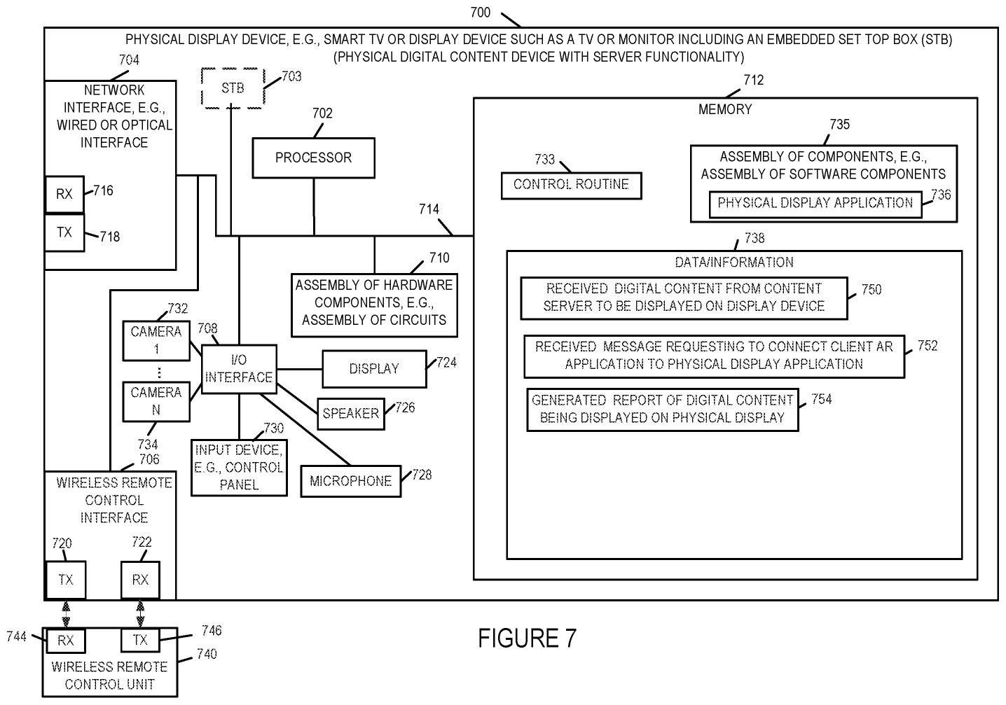

FIG. 7 is a drawing of an exemplary physical display device 700, e.g., a smart TV, or a display device such a TV or monitor including an embedded set-top-box, in accordance with an exemplary embodiment. The physical display device 700 is sometimes referred to as a physical digital content device with server functionality. Exemplary physical display device 700 is, e.g., TV 204 of FIG. 1, physical display 204 of FIG. 2, and/or a display device, e.g., TV, in the environment in which the user, wearing the HMD headset device is located, with respect to method of the flowchart of FIG. 5.

Exemplary physical display device 700 includes a processor 702, e.g., a CPU, a network interface 702, e.g., wired or optical interface, a wireless remote control interface 706, an I/O interface 708, an assembly of hardware circuits 710, and memory 712, coupled together via a bus 714 over which the various elements may interchange data and information. Physical display device 700 further includes a plurality of I/O devices (display 724, speaker 726, microphone 728, input device 730, e.g., a control panel, and a plurality of cameras (camera 1 732, . . . , camera N 734), coupled to I/O interface 708, which couples the various I/O devices to bus 714 and to other elements withing physical display device 700. In some embodiments physical display device 700 includes an embedded set top box (STB) 703, coupled to bus 714. Physical display device 700 further includes a wireless remote control unit 744, which interfaces with wireless remote control interface 706. Wireless remote control unit 744, which includes wireless receiver 744 and wireless transmitter 746, is a handheld user device which communicates with the wireless remote control interface 706 including wireless transmitter 720 and wireless receiver 722, via wireless radio signals or via wireless infrared signals.

Network interface 704, e.g., a wired or optical interface, includes receiver 716 and transmitter 718. Network interface 704 couples the physical display device, via a wire cable or optical fiber to a local network, a cable network and/or the Internet.

Memory 712 includes control routine 733 and assembly of components 735, e.g., an assembly of software components. Control routine 733 includes machine executable instructions, which when executed by processor 702 control the physical display device 700 to perform basic operations including read to memory, write to memory, operate an interface, etc. Assembly of software components 735 includes machine executable instructions, which when executed by processor 702 controls the physical display device 700 to perform steps of an exemplary method in accordance with the present invention, e.g., steps of the method of signaling diagram 200 of FIG. 2 and/or steps of the method of the flowchart of FIG. 5, which are performed by a display device, e.g., display device 204. Assembly of components 734 includes a physical display application 736, which interacts with the client AR application in the user device, e.g., user device 202, e.g., establishing a connection and communicating, e.g., reporting, information relating the content being displayed including, e.g., information indicating a particular object being displayed via digital content on display device 700 from which AR content can be rendered.

Data/information 738 includes received digital content 750 to be displayed on the physical display device, a received message 752 requesting to connect the client AR application to the physical display application, and a generated report 754 of digital content being displayed on the physical display device to be communicated to the user device, which is a client device including the client AR application.

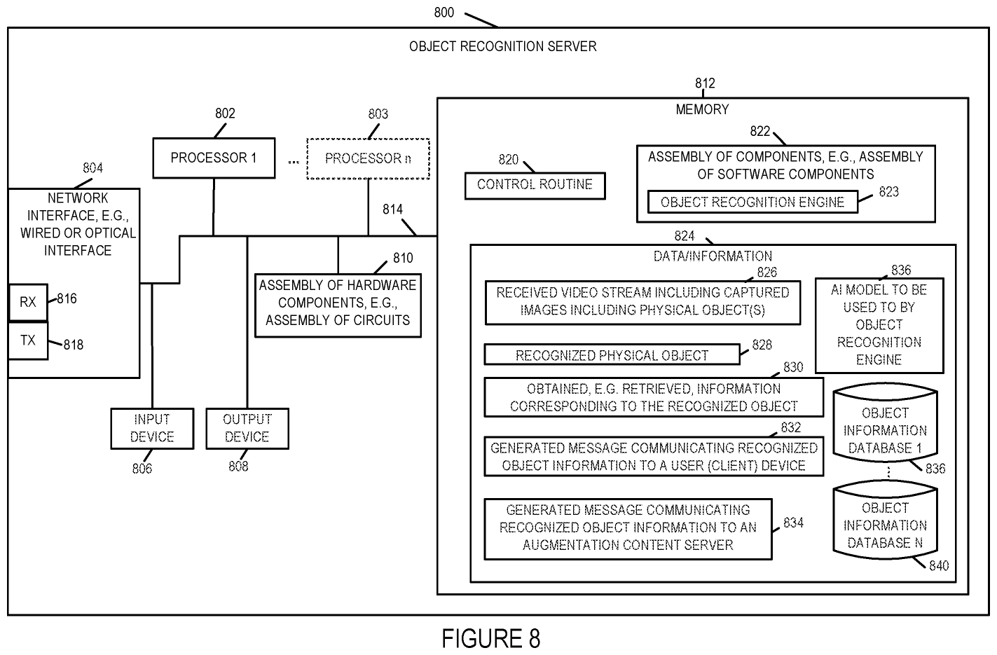

FIG. 8 is a drawing of an exemplary object recognition server 800 in accordance with an exemplary embodiment. Exemplary object recognition server 800 is, e.g., object recognition server 205 of FIG. 4, and/or an object recognition server shown or described with respect to the flowchart of FIG. 5.

Object recognition server 800 includes processor 1 802, network interface 804, e.g., a wired or optical interface, input device 806, e.g., a keyboard, output device 808, e.g., a display, assembly of hardware components 810, e.g., and assembly of circuits, and memory 812, coupled together via bus 814 over which the various elements may interchange data and information. In some embodiments, objection recognition device 800 includes a plurality of processors (processor 1 802, . . . processor N 803), e.g., a plurality of processor cores. Network interface 804 includes receiver 816 and transmitter 818. Memory 812 includes control routine 820, assembly of components 822, e.g., assembly of software components, and data/information 824.

Control routine 820 includes machine executable instructions, which when executed by processor one or more processors, e.g., processor 802 and/or processor 803 control the object recognition server 800 to perform basic operations including read to memory, write to memory, operate an interface, etc. Assembly of software components 822 includes machine executable instructions, which when executed by one or more processors, e.g., processor 802 and/or processor 803 control the object recognition server 800 to perform steps of an exemplary method in accordance with the present invention, e.g., steps of the method of signaling diagram 400 of FIG. 4 and/or steps of the flowchart of FIG. 5, which are performed by an object recognition server, e.g. object recognition server 405.

Assembly of components 822 includes an object recognition engine 823. Object recognition engine 836 processes a received video stream, e.g., video stream 826, from a user (client) device, which may include recognizable objects, and searches for objects, e.g., using AI model 836. Information 828 identifying a detected recognized physical object is an output of the object recognition engine processing.

Data/information 824 includes artificial intelligence (AI) model 836 to be used by the object recognition engine 823, a plurality of object information databases (object information database 1 836, . . . , object information database N 840), a received video stream 826 including captured images including physical object(s), information 828 identifying a recognized physical object, obtained, e.g., retrieved, information 830 corresponding to the recognized object, a generated message 832 to be sent to a user (client) device communicating recognized object information to the user (client) device, and a generated message 834 to be sent to a augmentation content server communicating recognized object information to the augmentation content server so that the augmentation content server can generate (render) high fidelity AR content corresponding to the recognized physical object, e.g., a duplicate or a slightly modified (e.g., different color) duplicate of the identified object.

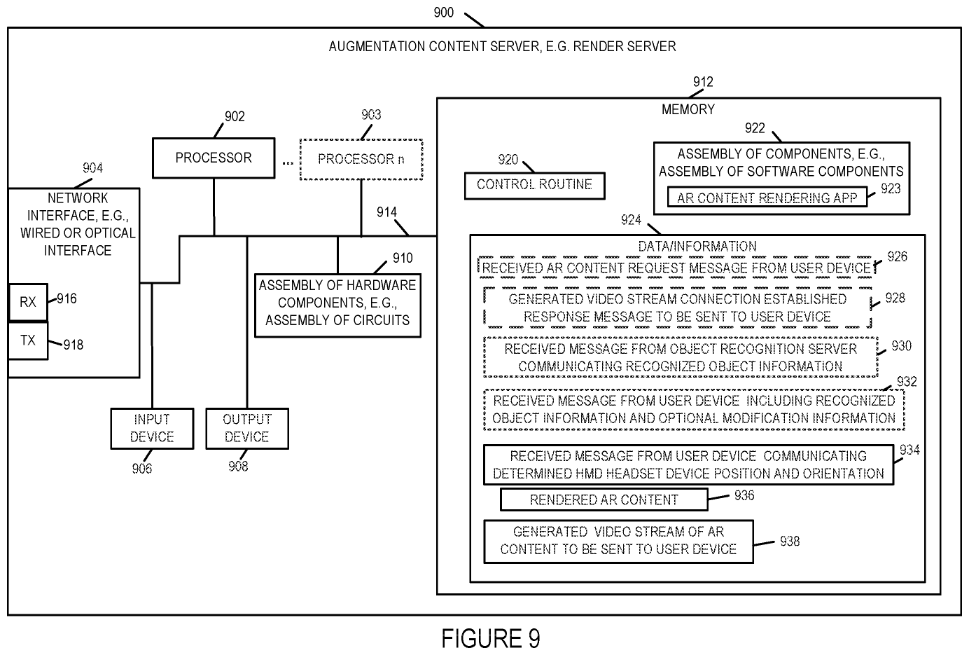

FIG. 9 is a drawing of an exemplary augmentation content server 900, e.g., a render server, in accordance with an exemplary embodiment. Exemplary object recognition server 900 is, e.g., exemplary augmentation server 206 of FIG. 2, FIG. 4, and/or an object recognition server shown or described with respect to the flowchart of FIG. 5.

Object recognition server 900 includes processor 1 902, network interface 904, e.g., a wired or optical interface, input device 906, e.g., a keyboard, output device 908, e.g., a display, assembly of hardware components 910, e.g., and assembly of circuits, and memory 912, coupled together via bus 914 over which the various elements may interchange data and information. In some embodiments, augmentation content server 900 includes a plurality of processors (processor 1 902, . . . processor N 903), e.g., a plurality of processor cores. Network interface 904 includes receiver 916 and transmitter 918.

Memory 912 includes control routine 920, assembly of components 922, e.g., assembly of software components, and data/information 924. Control routine 920 includes machine executable instructions, which when executed by processor one or more processors, e.g., processor 902 and/or processor 903 control the augmentation content server 900 to perform basic operations including read to memory, write to memory, operate an interface, etc. Assembly of software components 922 includes machine executable instructions, which when executed by one or more processors, e.g., processor 902 and/or processor 903 control the augmentation content server 900 to perform steps of an exemplary method in accordance with the present invention, e.g., steps of the method of signaling diagram 200 of FIG. 2, steps of the signaling diagram 400 of Figure and/or steps of the flowchart of FIG. 5, which are performed by an augmentation content server, e.g. augmentation content server 406.

Assembly of components 922 includes an AR content rendering APP 932 configured to receive and process information, e.g., object information, object modification information, and user device, e.g., HMD headset device, position and orientation information, render AR content based on the received information, and generate and send an AR content stream including the rendered AR content to a user device.

Data/information 924 includes a received AR content request message 926 from a user device, a generated video stream connection established response message 928 to be sent to a user device, a received message 930 from an object recognition server communicating recognized object information, a received message 932 from a user device communicating determined HMD headset device position and orientation information, rendered AR content 936 and a generated video stream 938 of AR content to be sent to a user device.

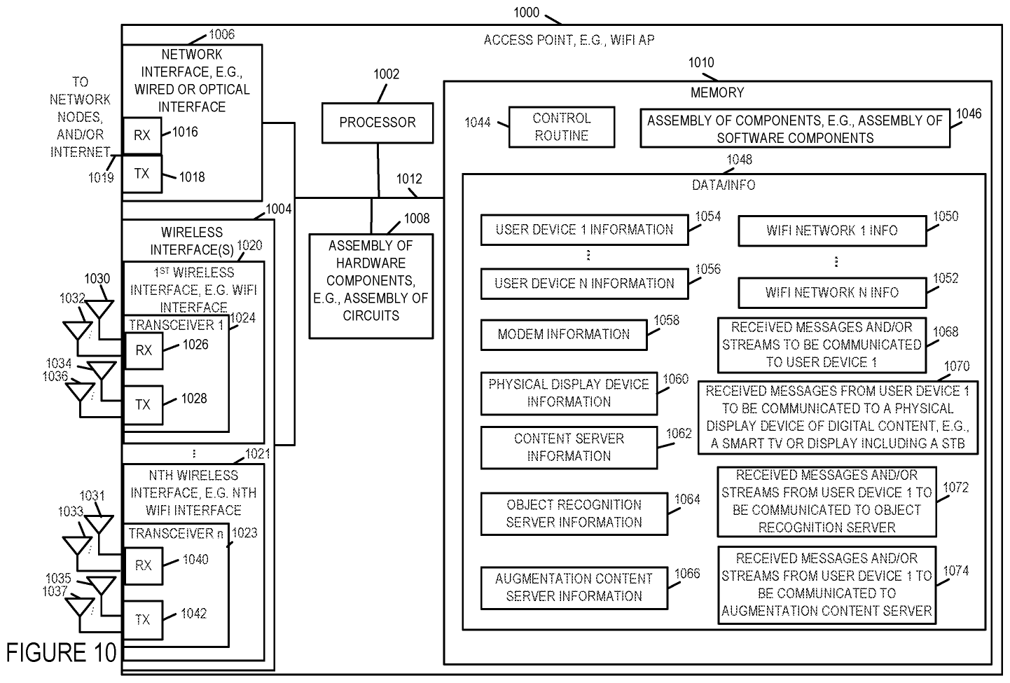

FIG. 10 is a drawing of an exemplary access point (AP) 1000, e.g., a WiFi AP, in accordance with an exemplary embodiment. Access point 1000 includes processor 1002, e.g., a CPU, wireless interface(s) 1004 and network interface 1006, assembly of hardware components 1008, e.g., an assembly of circuits, and memory 1010. Wireless interfaces 1004 includes 1st wireless interface 1020, e.g., a first WiFi interface and Nth wireless interface 1020, e.g., an Nth WiFi interface. Different WiFi interfaces may correspond to different frequency bands. In some embodiments, access point 1000 couples one or more user devices, e.g., MR and/or VR HMD headset devices supporting AR, to local networks, cable network, the Internet, and/or to one or more servers and/or databases, e.g., an augmentation content server and an object detection server.

1st wireless interface 1020 includes transceiver 1 1024, which includes wireless receiver 1026 and a wireless transmitter 1028. Wireless receiver 1026 is coupled to one or more receive antennas (1030, . . . , 1032) via which the access point 1000 receives wireless signals, e.g., WiFi signals, from user devices, e.g., HMD headset devices supporting AR. Wireless transmitter 1028 is coupled to one or more transmit antennas (1034, . . . , 1036) via which the access point 1000 transmits wireless signals, e.g., WiFi signals, to user devices, e.g., HMD headset devices supporting AR. Nth wireless interface 1021 includes transceiver n 1023, which includes wireless receiver 1040 and a wireless transmitter 1042. Wireless receiver 1040 is coupled to one or more receive antennas (1031, . . . , 1033) via which the access point 1000 receives wireless signals, e.g., WiFi signals, from user devices, e.g., HMD headset devices supporting AR. Wireless transmitter 1042 is coupled to one or more transmit antennas (1035, . . . 1037) via which the access point 1000 transmits wireless signals, e.g., WiFi signals, to user devices, e.g., HMD headset devices supporting AR.

Memory 1010 includes control routine 1044, assembly of components 1046, e.g., an assembly of software components, and data/information 1048. Control routine 1044 includes machine executable instructions, which when executed by a processor, e.g., processor 1002, control the AP 1000 to perform basic operations including read to memory, write to memory, operate an interface, etc. Assembly of software components 1045 includes machine executable instructions, which when executed a processor 1002, control the AP 1000 to perform operations related to steps of an exemplary method in accordance with the present invention, e.g., operations related to steps of the method of signaling diagram 400 of FIG. 4 and/or related to steps of the flowchart of FIG. 5, which are performed by an AP, e.g., AP 1000, said operations including message and data forwarding between a user device, e.g. user device 200 and other devices, e.g. display device 204, object recognition server 205, and augmentation content server 206.

Data/information 1048 includes user device 1 information 1054, e.g., user device 1 202 ID, address and capability information, user device N information 1056, e.g., user device N 203 ID, address and capability information, modem information 1058, e.g., modem 1110 ID, address and capability information, physical display device information 1060, e.g., physical display device 204 ID, address and capability information, content server information, e.g., content server 1114 ID and address information, object recognitions server information, e.g., object recognition server ID, address, and capability information (e.g., including information including types (or particular sets of classifications of objects) which can be detected by the object recognition server, and augmentation content server information, e.g. augmentation content server 206 ID, address and capability information (e.g., including information identifying the options for the rendered AR content, e.g. resolution, update rate, etc.). Data/information 1048 further includes information corresponding to one or more WiFi network of AP 1000 (WiFi network 1 information 1050, . . . , WiFi network N information 1052). Each set of WiFi network information includes, e.g., bandwidth information, time/frequency structure information, and ID information. Data/information 1048 further includes received messages and/or streams 1068 (e.g., from a physical display device, an object recognition server, or an augmentation content server) to be communicated to user device 1, received messages and/or streams 1070 from user device 1 to be communicated to a display device, e.g., a smart TV, received messages and/or streams from user device 1 to be communicated to an object recognition server, and received messages and/or streams from user device 1 to be communicated to an augmentation content server.

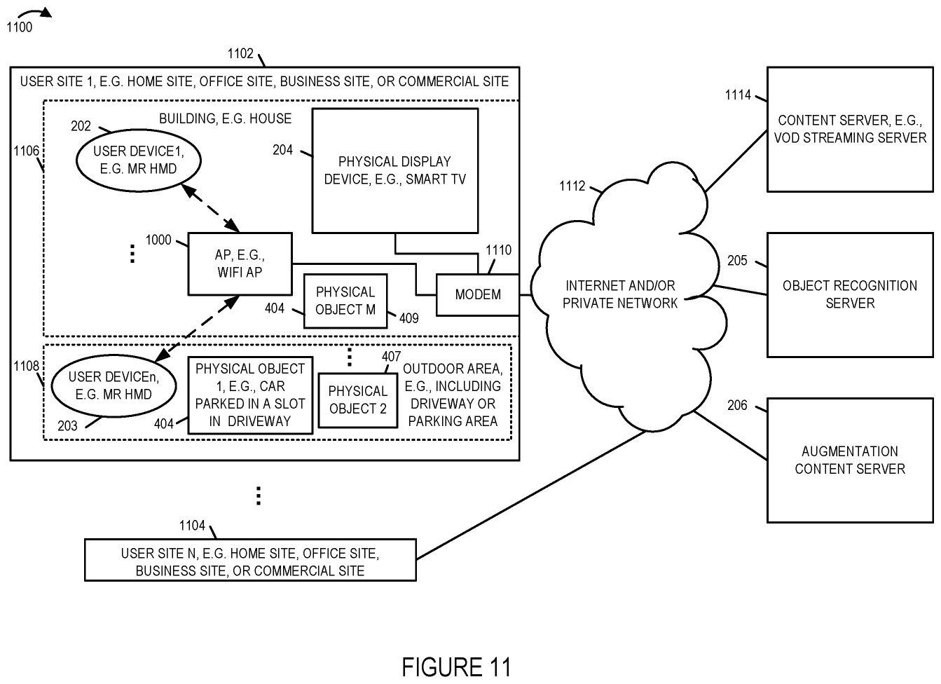

FIG. 11 is a drawing of an exemplary system 1100 in accordance with an exemplary embodiment. Exemplary system 1100 implements methods in accordance with signaling diagram 200 of FIG. 2, signaling diagram 400 of FIG. 4, and/or flowchart 500 of FIG. 5.

Exemplary communications system 1100 includes a plurality of user sites (user site 1 1102, e.g., a home site, office site, business site, or commercial site, . . . , user site N 1104), a content server 1114, e.g., a VOD streaming server, an object recognition server 205, and an augmentation content server 206, e.g., render server, coupled together via the Internet and/or private network 1112. In some embodiments, an object recognition server and/or an augmentation content server may be located at a user site, e.g., user site 1 1102.

Exemplary user site 1 1102 includes a building 1106, e.g., a house, and an outdoor area 1108, e.g., including a driveway or parking area. User site 1 1102 includes a plurality of user devices (user device 1 202, e.g., MR HMD 1, . . . , user device n 203, e.g., MR HMD n). At least some of the user devices are mobile devices which may move throughout the user site and be located at different positions at different times and have a different orientation at different times.

User site 1 1102 further includes a plurality of physical objects (physical object 1 404, e.g., a car which is parked in a slot in a driveway within outdoor area 1108, physical object 2 407 located within outdoor area 1108 and physical object M 409 located within building 1106.

Building 1106 includes access point (AP) 1000, modem 1110, and physical display device 204, e.g., a smart TV optionally including a STB. The AP 1000 and the physical display device 204 are coupled to modem 1110, which is coupled to the Internet and/or private network 1112. In some embodiments, the modem is included as part of the AP 1000. Content, e.g., video content including programs, e.g., user selected content, and commercials are streamed from content server 1114, via the Internet and/or private network 1112 and modem 1110 to physical display device 204. A user device, e.g., user device 202 which is a MR HMD device, sends its position and orientation information to augmentation content server. Augmentation content server 206 may, and sometimes does render synchronized AR content, corresponding to objects, e.g., a car, displayed on physical display device 204, said rendered AR content, e.g., a high fidelity AR model of the car, being sent in a video steam of AR content to a user device, e.g., MR HMD user device 1 202, to be displayed to the user. Thus, video content being displayed on the physical display device 204 can be, and sometimes is, synchronized with AR content, e.g., a high fidelity AR model, being presented to a user wearing a MR HMD device.

In some embodiments, a camera included in a user device captures a video stream including images of one or more object, and the captured video stream is communicated to and processed by an object recognition server which searches for and identifies objects. Information corresponding to an identified object is obtained, e.g., retrieved from one or more databases and sent to the user device and/or to the augmentation server. The user device may, and sometimes does, select to change particular features corresponding to the identified object, e.g., color, and communicate modification information to the augmentation content server 206. The user device, e.g., user device 202 which is a MR HMD device, sends its position and orientation information to augmentation content server. Augmentation content server 206 may, and sometimes does, render synchronized AR content, corresponding to an identified object, e.g., an identified car 404, said rendered AR content, e.g., a high fidelity AR model of the car, may, and sometimes does, include one or more user selected modifications, e.g., a color change, with respect to the identified object. The rendered AR content is sent in a video stream of AR content to the user device, e.g., MR HMD user device 1 202, to be displayed to the user.

### Numbered List of Exemplary Method Embodiments

Method Embodiment 1. A method of providing an augmented reality experience (e.g., an augmented virtual reality or augmented mixed reality experience) to a user, the method comprising: receiving (520) information at an augmentation content server (e.g., from an object recognition app running on an object recognition server or the content server providing digital program or application content being displayed) indicating a first object being viewed by the user or information indicating video content (e.g., based on content information from the content server, e.g., a server in a STB or TV device) being viewed by the user; determining (526) supplemental content (image of a car) corresponding the first object being viewed or the video content being viewed to be provided; generating (528), at the augmentation content server, an augmented content reality video stream (e.g., e.g., a high definition video content stream, which can include a mode and surface to be applied to the model as part of the augmented content display process) including supplemental content (which is intended to supplement and thus augment the environment being viewed and/or the digital content being viewed); and supplying (530) the augmented content reality stream to a user device that supports one or both of i) a virtual reality application or ii) a mixed reality application.

Method Embodiment 2. The method of Method Embodiment 1, wherein the user device is a head mounted display (HMD) headset (e.g., VR and/or mixed reality (MR) headset) being worn by the user for presentation to the user (e.g., as part of an augmented digital video presentation or as part of an augmented reality experience).

Method Embodiment 3. The method of Method Embodiment 1, wherein the user device is a pair of augmented reality glasses capable of displaying supplemental content included in the augmented reality stream.

Method Embodiment 1A. The method of Method Embodiment 1, wherein said user device is a cell phone which includes a camera and a display, said displaying being configured to display content captured by the camera along with supplemental content included in the augmented reality stream.

Method Embodiment 4. The method of Method Embodiment 1, wherein the augmented reality content stream includes rendered images which can be combined with digital content being displayed on the display of the HMD headset and/or displayed while objects in the environment are being viewed through the display device of the HMD headset (e.g. images of the environment captured with a forward facing camera are displayed with supplemental content on a display on the rear of the camera to provide a user an augmented reality experience).

Method Embodiment 5. The method of Method Embodiment 4, wherein the augmented reality image stream is used as an augmentation image layer that is combined with the digital content being displayed on the display of the HMD headset (in some embodiments the digital content being displayed corresponds to one or more image layers that are combined in the HMD headset with the augmentation image layer to generate the displayed image content).

Method Embodiment 6. The method of Method Embodiment 1, further comprising: receiving user color preference information; and wherein generating (528), at the augmentation content server, the augmented content reality video stream includes generating an image of an object having a color matching the color preference of the user (e.g., generate an image of a car, shirt or other object which may be purchased by the user having the color indicated by the received user color preference information).

Method Embodiment 7. The method of Method Embodiment 1, further comprising: receiving user item features or model preference information; and wherein generating (528), at the augmentation content server, the augmented content reality video stream includes generating an image of an object having the features or corresponding to a model indicated by the item feature and/or model preference information (e.g., generate an image of a car or shirt corresponding to the car model specified by the user and indicated by received car model information and/or a shirt having the feature of a monogram or embroidery (company name, user name or logo) indicated by the received item feature information).

Method Embodiment 8. The method of Method Embodiment 7, further comprising: receiving user color preference information; and receiving user preferred item feature information or user model preference information; and wherein generating (528), at the augmentation content server, the augmented content reality video stream includes generating an image of an object having the color indicated by the received color preference information and i) features indicated by the received user preferred item feature information and/or or displaying a model of an item, e.g., car or other object, indicated by the user model preference information.

Method Embodiment 9. The method of Method Embodiment 1, wherein the user device includes a camera; and wherein the method includes receiving (522) information at the augmentation content server indicating a first object being viewed by the user; and wherein the method further includes: receiving (506), at an object recognition device, (which may be a different server or the augmentation content server) video content captured by the user device; performing (508), at the object recognition device, an object recognition on the received video content; and identifying (512) said first object in received video content (where the first object is one of multiple objects that are recognized).

Method Embodiment 10. The method of Method Embodiment 9, further comprising: operating (504) an application on the user device (e.g., VR and/or MR headset) to contact the object recognition device (e.g., object recognition server) and supply video of content captured by a camera on the user device (e.g., VR and/or MR headset); and operating (514) the object recognition device (e.g., object recognition server) to supply information about detected objects to the supplemental content server or operating the user device (headset) to supply information about detected objects received from the object recognition device (e.g., server) to the augmentation content server.

Method Embodiment 11. The method of Method Embodiment 1, wherein the method includes receiving (520) information at the supplemental augmentation content server includes receiving (524) information indicating content being viewed by the user from a content streaming server (e.g., in a STB, TV or network steaming server) or indicating content being streamed to the user device in the environment in which the user is located.

Method Embodiment 11A. The method of Method Embodiment 11, further comprising: operating (508) an application on the user device to contact the content steaming server to obtain content to be displayed to the user of the HMD headset (in case where streamed content is displayed on headset with supplemental content); and operating (510) the application on the user device to provide information about the content being obtained from the content streaming server to the augmentation content server or operating the content streaming server to supply information, about the content being streamed, to the augmentation content server.

Method Embodiment 12. The method of Method Embodiment 11, further comprising: controlling (532) user device to display the supplemental content to the user.

Method Embodiment 13. The method of Method Embodiment 12, wherein displaying the supplemental content to the user includes displaying (534) the content on a display device, of the user device, through which the environment in which the user is located is being viewed or displaying the supplemental content to the user as part of a display of video content captured by a camera of the user device.

### Numbered List of Exemplary System Embodiments

System Embodiment 1. A system for providing an augmented reality experience to a user, comprising: an augmentation content server (206 or 900) including: a network interface (904); and a first processor (902) configured to control the augmentation content server to: receive (520) information at the augmentation content server (e.g., from an object recognition app running on an object recognition server or the content server providing digital program or application content being displayed) indicating a first object being viewed by the user or information indicating video content (e.g., based on content information from the content server, e.g., a server in a STB or TV device) being viewed by the user; determine (526) supplemental content (image of a car) corresponding the first object being viewed or the video content being viewed to be provided; generate (528), at the augmentation content server, an augmented content reality video stream (e.g., a high definition video content stream, which can include a mode and surface to be applied to the model as part of the augmented content display process) including supplemental content (which is intended to supplement and thus augment the environment being viewed and/or the digital content being viewed); and supply (530) the augmented content reality stream to a user device that supports one or both of i) a virtual reality application or ii) a mixed reality application.

System Embodiment 2. The system of System Embodiment 1, wherein the user device is a head mounted display (HMD) headset (e.g., VR and/or mixed reality (MR) headset) being worn by the user for presentation to the user (e.g., as part of an augmented digital video presentation or as part of an augmented reality experience).

System Embodiment 3. The system of System Embodiment 1, wherein the user device is a pair of augmented reality glasses capable of displaying supplemental content included in the augmented reality stream.

System Embodiment TA. The system of System Embodiment 1, wherein said user device is a cell phone which includes a camera and a display, said display being configured to display content captured by the camera along with supplemental content included in the augmented reality stream.

System Embodiment 4. The system of System Embodiment 1, wherein the augmented reality content stream includes rendered images which can be combined with digital content being displayed on the display of the HMD headset and/or displayed while objects in the environment are being viewed through the display device of the HMD headset (e.g. images of the environment captured with a forward facing camera are displayed with supplemental content on a display on the rear of the camera to provide a user an augmented reality experience).

System Embodiment 5. The system of System Embodiment 4, wherein the augmented reality image stream is used as an augmentation image layer that is combined with the digital content being displayed on the display of the HMD headset (in some embodiments the digital content being displayed corresponds to one or more image layers that are combined in the HMD headset with the augmentation image layer to generate the displayed image content).

System Embodiment 6. The system of System Embodiment 1, wherein the first processor is further configured to control the augmentation content server to: receive user color preference information; and wherein generating (528), at the augmentation content server, the augmented content reality video stream includes generating an image of an object having a color matching the color preference of the user (e.g., generate an image of a car, shirt or other object which may be purchased by the user having the color indicated by the received user color preference information).

System Embodiment 7. The system of System Embodiment 1, wherein the first processor is further configured to control the augmentation content server to: receive user item features or model preference information; and wherein generating (528), at the augmentation content server, the augmented content reality video stream includes generating an image of an object having the features or corresponding to a model indicated by the item feature and/or model preference information (e.g., generate an image of a car or shirt corresponding to the car model specified by the user and indicated by received car model information and/or a shirt having the feature of a monogram or embroidery (company name, user name or logo) indicated by the received item feature information).

System Embodiment 8. The system of System Embodiment 7, wherein the first processor is further configured to control the augmentation content server to: receive user color preference information; and receive user preferred item feature information or user model preference information; and wherein generating (528), at the augmentation content server, the augmented content reality video stream includes generating an image of an object having the color indicated by the received color preference information and features indicated by the received user preferred item feature information and/or displaying a model of an item (e.g., car or other object) indicated by the user model preference information.

System Embodiment 9. The system of System Embodiment 1, wherein the user device includes a camera.

### Numbered List of Non-Transitory Machine Readable Embodiments

Non-transitory Machine Readable Embodiment 1. A non-transitory machine readable medium including processor executable instructions which when executed by a processor of an augmentation content server controls the augmentation content server to: receive information at an augmentation content server indicating a first object being viewed by the user or information indicating video content being viewed by the user; determine supplemental content corresponding the first object being viewed or the video content being viewed to be provided; generate, at the augmentation content server, an augmented content reality video stream including supplemental content; and supply the augmented content reality stream to a user device that supports one or both of i) a virtual reality application or ii) a mixed reality application.

The techniques of various embodiments may be implemented using software, hardware and/or a combination of software and hardware. Various embodiments are directed to apparatus, e.g., user devices, e.g., compute and display devices supporting augmented and/or mixed reality, e.g., smartphones, lightweight AR glasses, mixed reality (MR) head mounted display (HMD) devices, or a virtual reality (VR) head mounted display (HMD) devices utilizing augmented reality (AR) pass through, display devices, e.g., smart TVs or other display devices such as a monitor including an embedded set top box (STB), access points, e.g., WiFi APs, object recognition servers, e.g., specialized AI object recognition servers customized to a particular set or sets of objects to be detected and recognized, augmentation content servers, e.g., render servers, content servers, e.g., video on demand (VOD) content servers, commercial advertising content servers, specialized content servers for businesses and/or museums, etc., routers, and/or other network devices. Various embodiments are also directed to methods, e.g., method of controlling and/or user devices, e.g., compute and display devices supporting augmented and/or mixed reality, e.g., smartphones, lightweight AR glasses, mixed reality (MR) head mounted display (HMD) devices, or a virtual reality (VR) head mounted display (HMD) devices utilizing augmented reality (AR) pass through, display devices, e.g., smart TVs or other display devices such as a monitor including an embedded set top box (STB), access points, e.g., WiFi APs, object recognition servers, e.g., specialized AI object recognition servers customized to a particular set or sets of objects to be detected and recognized, augmentation content servers, e.g., render servers, content servers, e.g., video on demand (VOD) content servers, commercial advertising content servers, specialized content servers for businesses and/or museums, etc., routers, and/or other network devices. Various embodiments are also directed to a machine, e.g., computer, readable medium, e.g., ROM, RAM, CDs, hard discs, etc., which include machine readable instructions for controlling a machine to implement one or more steps of a method, e.g., any one of the methods described herein. The computer readable medium is, e.g., non-transitory computer readable medium. It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., user devices, e.g., compute and display devices supporting augmented and/or mixed reality, e.g., smartphones, lightweight AR glasses, mixed reality (MR) head mounted display (HMD) devices, or a virtual reality (VR) head mounted display (HMD) devices utilizing augmented reality (AR) pass through, display devices, e.g., smart TVs or other display devices such as a monitor including an embedded set top box (STB), access points, e.g., WiFi APs, object recognition servers, e.g., specialized AI object recognition servers customized to a particular set or sets of objects to be detected and recognized, augmentation content servers, e.g., render servers, content servers, e.g., video on demand (VOD) content servers, commercial advertising content servers, specialized content servers for businesses and/or museums, etc., routers, and/or other network devices, described herein are implemented using one or more components to perform the steps corresponding to one or more methods. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, user devices, e.g., compute and display devices supporting augmented and/or mixed reality, e.g., smartphones, lightweight AR glasses, mixed reality (MR) head mounted display (HMD) devices, or a virtual reality (VR) head mounted display (HMD) devices utilizing augmented reality (AR) pass through, display devices, e.g., smart TVs or other display devices such as a monitor including an embedded set top box (STB), access points, e.g., WiFi APs, object recognition servers, e.g., specialized AI object recognition servers customized to a particular set or sets of objects to be detected and recognized, augmentation content servers, e.g., render servers, content servers, e.g., video on demand (VOD) content servers, commercial advertising content servers, specialized content servers for businesses and/or museums, etc., routers, and/or other network devices, include a processor configured to control the device to perform steps in accordance with one of the methods described herein.

The configuration of the processor may be achieved by using one or more components, e.g., software components, to control processor configuration and/or by including hardware in the processor, e.g., hardware components, to perform the recited steps and/or control processor configuration.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above.

Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in user devices, e.g., compute and display devices supporting augmented and/or mixed reality, e.g., smartphones, lightweight AR glasses, mixed reality (MR) head mounted display (HMD) devices, or a virtual reality (VR) head mounted display (HMD) devices utilizing augmented reality (AR) pass through, display devices, e.g., smart TVs or other display devices such as a monitor including an embedded set top box (STB), access points, e.g., WiFi APs, object recognition servers, e.g., specialized AI object recognition servers customized to a particular set or sets of objects to be detected and recognized, augmentation content servers, e.g., render servers, content servers, e.g., video on demand (VOD) content servers, commercial advertising content servers, specialized content servers for businesses and/or museums, etc., routers, and/or other network devices, for example, but could be in other devices as well. In some embodiments, components are implemented as hardware devices in such embodiments the components are hardware components. In other embodiments components may be implemented as software, e.g., a set of processor or computer executable instructions. Depending on the embodiment the components may be all hardware components, all software components, a combination of hardware and/or software or in some embodiments some components are hardware components while other components are software components.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of providing an augmented reality experience to a user, the method comprising:
receiving information at an augmentation content server indicating a first object being viewed by the user or information indicating video content being viewed by the user;
determining supplemental content corresponding the first object being viewed or the video content being viewed to be provided;
generating, at the augmentation content server, an augmented content reality video stream including supplemental content; and
supplying the augmented content reality stream to a user device that supports one or both of i) a virtual reality application or ii) a mixed reality application.

2. The method of claim 1, wherein the user device is a head mounted display (HMD) headset being worn by the user for presentation to the user.

3. The method of claim 1, wherein the user device is a pair of augmented reality glasses capable of displaying supplemental content included in the augmented reality stream.

4. The method of claim 1, wherein the augmented reality content stream includes rendered images which can be combined with digital content being displayed on the display of the HMD headset and/or displayed while objects in the environment are being viewed through the display device of the HMD headset.

5. The method of claim 4, wherein the augmented reality image stream is used as an augmentation image layer that is combined with the digital content being displayed on the display of the HMD headset.

6. The method of claim 1, further comprising:
receiving user color preference information; and
wherein generating, at the augmentation content server, the augmented content reality video stream includes generating an image of an object having a color matching the color preference of the user.

7. The method of claim 1, further comprising:
receiving user item features or model preference information; and
wherein generating, at the augmentation content server, the augmented content reality video stream includes generating an image of an object having the features or corresponding to a model indicated by the item feature and/or model preference information.

8. The method of claim 7, further comprising:
receiving user color preference information; and
receiving user preferred item feature information or user model preference information; and
wherein generating, at the augmentation content server, the augmented content reality video stream includes generating an image of an object having the color indicated by the received color preference information and features indicated by the received user preferred item feature information and/or displaying a model of an item indicated by the user model preference information.

9. The method of claim 1,
wherein the user device includes a camera; and
wherein the method includes receiving information at the augmentation content server indicating a first object being viewed by the user; and
wherein the method further includes:
receiving, at an object recognition device, video content captured by the user device;
performing, at the object recognition device, an object recognition on the received video content; and
identifying said first object in received video content.

10. The method of claim 9, further comprising:
operating an application on the user device to contact the object recognition device and supply video of content captured by a camera on the user device; and
operating the object recognition device to supply information about detected objects to the supplemental content server or operating the user device to supply information about detected objects received from the object recognition device to the augmentation content server.

11. The method of claim 1, wherein the method includes receiving information at the supplemental augmentation content server includes receiving information indicating content being viewed by the user from a content streaming server or indicating content being streamed to the user device in the environment in which the user is located.

12. The method of claim 11, further comprising:
controlling user device to display the supplemental content to the user.

13. The method of claim 12, wherein displaying the supplemental content to the user includes displaying the content on a display device, of the user device, through which the environment in which the user is located is being viewed or displaying the supplemental content to the user as part of a display of video content captured by a camera of the user device.

14. A system for providing an augmented reality experience to a user, comprising:
an augmentation content server including:
a network interface; and
a first processor configured to control the augmentation content server to:
receive information at the augmentation content server indicating a first object being viewed by the user or information indicating video content being viewed by the user;
determine supplemental content corresponding the first object being viewed or the video content being viewed to be provided;
generate, at the augmentation content server, an augmented content reality video stream including supplemental content; and
supply the augmented content reality stream to a user device that supports one or both of i) a virtual reality application or ii) a mixed reality application.

15. The system of claim 14, wherein the user device is a head mounted display (HMD) headset being worn by the user for presentation to the user.

16. The system of claim 14, wherein the user device is a pair of augmented reality glasses capable of displaying supplemental content included in the augmented reality stream.

17. The system of claim 14, wherein the augmented reality content stream includes rendered images which can be combined with digital content being displayed on the display of the HMD headset and/or displayed while objects in the environment are being viewed through the display device of the HMD headset.

18. The system of claim 17, wherein the augmented reality image stream is used as an augmentation image layer that is combined with the digital content being displayed on the display of the HMD headset.

19. The system of claim 14, wherein the first processor is further configured to control the augmentation content server to:
receive user color preference information; and
wherein generating, at the augmentation content server, the augmented content reality video stream includes generating an image of an object having a color matching the color preference of the user.

20. A non-transitory machine readable medium including processor executable instructions which when executed by a processor of an augmentation content server controls the augmentation content server to:
receive information at an augmentation content server indicating a first object being viewed by the user or information indicating video content being viewed by the user;
determine supplemental content corresponding the first object being viewed or the video content being viewed to be provided;
generate, at the augmentation content server, an augmented content reality video stream including supplemental content; and
supply the augmented content reality stream to a user device that supports one or both of i) a virtual reality application or ii) a mixed reality application.
